(19) United States
(12) Patent Application Publication
(10) Pub. No.: US 2008/0282255 A1
(43) Pub. Date: Nov. 13, 2008

(54) HIGHLY-AVAILABLE APPLICATION OPERATION METHOD AND SYSTEM, AND METHOD AND SYSTEM OF CHANGING APPLICATION VERSION ON LINE

(76) Inventors: Shinichi Kawamoto, Tokyo (JP); Tomohiro Nakamura, Hachioji (JP); Tsunehiko Baba, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/833,090

(22) Filed: Aug. 2, 2007

(30) Foreign Application Priority Data
May 9, 2007 (JP) 2007-124311

(51) Int. Cl. G06F 13/14

(52) U.S. Cl. 719/312

(57) ABSTRACT

By releasing a part of execution environment that contains a leaked resource, a failure is avoided while the remaining part of execution environment in a memory and the like prevents performance degradation that results from a cold cache. This invention provides a highly available application operation method for replacing a first application (App1) which receives a processing request with a second application (App2). The method includes the steps of: invoking the first application (App1) and forwarding the processing request to the first application (App1); when a given condition is met, invoking the second application (App2) and forwarding a new processing request to the second application (App2); and, when the first application (App1) completes the processing request after the second application (App2) is invoked, stopping the first application (App1).

### CLAIM OF PRIORITY

The present application claims priority from Japanese application P2007-124311 filed on May 9, 2007, the content of which is hereby incorporated by reference into this application.

### BACKGROUND OF THE INVENTION

This invention relates to an improved method of running an application server which executes an application service over the Internet or other networks.

In recent years, information systems have found their uses everywhere, and a failure in an information system can greatly affect society, which has become a social issue. An information system is divided into hardware components such as a server and storage system and software components such as an OS and an application. A hardware failure can be shielded by widely used techniques of redundant disks or power supplies and employing a cluster configuration which is constituted of a plurality of servers. Most software failures are caused by bugs. Usually, years are spent for OS bug fix, and a failure is rarely caused by a bug in an OS. Meanwhile, applications, which are now often loaded as Web applications owing to the advance of Web technologies. Web sites that use such Web applications to provide application services over the Internet or other networks compete fiercely with one another, and are all busy modifying or adding functions frequently to meet the preferences of their customers. A frequent modification or addition of a function means a limited time for development and testing of an application, which may not be enough to thoroughly test the application. Consequently, there is a high possibility that bugs remain in a Web application that has started to be run for real to actually provide a service to customers, and cause a failure in the system, forcing the Web site to stop the service. Improving the reliability of Web applications is therefore important for improvement of the reliability of information systems. While most Web application failures are caused by bugs in Web applications as mentioned above, limited manpower in developing a Web application and other factors make it impossible to completely eliminate bugs from a Web application. This fact has turned people's attention to system operation methods that allow a system to continue to provide a service despite bugs in a Web application.

Resource leak, such as memory leak, is a well known bug which causes the service of Web application down.

It is a known fact that many of failures caused by bugs are temporarily solved by rebooting the Web application, and some Web sites running Web applications regularly reboot the Web applications in order to prevent a failure.

However, the above method entails temporary suspension of the application service. As a way to avoid failure caused by resource leak of an application without interrupting a service of the application, a technique has been proposed which prevents failures from shutting down an application by giving an application server a cluster configuration and executing failover at given time intervals to reset (reboot) the former active OS or application (see JP 2001-188684 A, for example).

In another technique that has been proposed, during execution of an application, an identical application is newly invoked in a different memory space to make a switch from the current application to the newly invoked application so that the currently provided application service is provided by the newly invoked application (see JP 2002-259142 A, for example).

A technique of preventing the use of a newly invoked application from degrading performance has also been proposed in which the new application is allocated only a few requests at first and then a gradually increasing number of requests with time (see JP 2005-92862 A, for example).

### SUMMARY OF THE INVENTION

In JP 2001-188684 A and JP 2002-259142 A, however, a switch from an active application to a newly invoked application requires stopping the active application first before switching to the newly invoked standby application. The switch from the active application to the standby application causes not only temporary suspension of an application service but also a temporary drop in processing performance of the application.

There is another problem in JP 2001-188684 A, where the operation of an application service that is currently being provided is taken over by an application, OS, and hardware of a new instance that are entirely different from the currently used application, OS, and hardware, and in JP 2002-259142 A, where a new application different from an application that has been providing a service takes over the operation of the service. Immediately after a switch is made to a newly invoked standby application, various caches in the computer, such as a CPU cache memory and disk cache of the server, do not have information necessary to execute the application, resulting in many cache misses and degrading of application execution performance. A cache that does not have necessary information is called a cold cache.

JP 2005-92862 A has a solution to the cold cache problem which involves allocating a newly invoked application only a few requests at first and then an increasing number of requests with time, thereby gradually warming a cold cache and improving the cache hit rate. This almost completely prevents performance degradation when the standby application is newly invoked. A drawback to this approach is that a switch from the active application to the standby application takes long, sometimes long enough that free memory spaces are used up by the active application, which can result in a failure.

An objective of this invention is therefore to, instead of replacing the entirety of an active application with a newly invoked standby application and discarding the active application to free up memory spaces, release “a part of” an application that contains a leaked resource by newly invoking a part of another application as a standby application, thus avoiding a failure and at the same time leaving a part of execution environment in a CPU cache memory and other caches, which prevents a rise in cache miss rate and minimizes performance degradation.

An application according to an embodiment of this invention is a Web application. Web applications are run in middleware such as JAVA virtual machines (JVMs) and application servers or others that are run in JVMs. Whereas conventional applications are run in an OS, the concept of “application” in Web applications includes JVMs and application servers. JVMs and application servers are middleware provided by software venders, who conduct thorough debugging and other necessary checks before shipping, and contain almost no defects such as resource leak. Web applications, on the other hand, have a possibility of resource leak and other software bugs as mentioned above. The inventors of this invention have therefore thought of replacing a Web application alone with a standby Web application. This invention provides a highly available application operation method for replacing a first Web application which receives a processing request with a second Web application, and the method includes the steps of: forwarding requests from clients to the first Web application deployed in an application server; when a given condition is met, invoking the second Web application and forwarding the requests received after the completion of the invocation to the second Web application; and, when the first Web application completes the processing of all requests received after the completion of second Web application invocation, stopping the first Web application.

The application operation method according to an embodiment of this invention also includes creating, from a given application, the first Web application and the second Web application which have the same function as the application and different identifiers.

According to an embodiment of this invention, a leaked memory that has been used by the formerly active first Web application is freed at the time the first Web application is stopped, and a Web application failure due to memory leak is thus prevented. In addition, because the first Web application alone is replaced with the second Web application whereas a JVM and the application server are kept in use, the codes of the JVM and the application server remain in a CPU, a disk cache, and the like, which minimizes the lowering of the cache hit rate immediately after the switch to the second Web application is made, and prevents performance degradation.

Furthermore, the first Web application is replaced with the second Web application without suspending reception of requests and, accordingly, the switch is smoothly made without lowering the processing performance of the service.

### BRIEF DESCRIPTION OF THE DRAWINGS

FIG. 1 is a block diagram of a computer system to which this invention is applied according to a first embodiment.

FIG. 2 is a block diagram showing software configurations at the respective tiers of a Web 3-tier application (a business operation system) according to the first embodiment.

FIG. 3 is a block diagram showing functions of an application server according to the first embodiment.

FIG. 4 is a block diagram showing an example of what function a deploy tool has according to the first embodiment.

FIG. 5 is an explanatory diagram showing an example of a deployment operation window in the first embodiment which is provided to an administration console by a user interface.

FIG. 6 is an explanatory diagram showing an example of an application list window, which is provided to the administration console by the user interface according to the first embodiment.

FIG. 7 is a flow chart showing an example of deploy processing, which is executed by a controller of the deploy tool according to the first embodiment.

FIG. 8 is a flow chart showing an example of application starting processing, which is executed by the controller of the deploy tool according to the first embodiment.

FIG. 9 is a flow chart showing an example of application stopping processing, which is executed by the controller of the deploy tool according to the first embodiment.

FIG. 10 is a flow chart showing an example of application undeploying processing, which is executed by the controller of the deploy tool according to the first embodiment.

FIG. 11 is a block diagram showing details of processing that is executed by an application manager in Step S2 of FIG. 7 according to the first embodiment.

FIG. 12 is an explanatory diagram showing an example of an identifier definition file according to the first embodiment.

FIG. 13 is an explanatory diagram showing an example of session sharing information according to the first embodiment.

FIG. 14 is an explanatory diagram showing an example of a structure management file according to the first embodiment.

FIG. 15 is an explanatory diagram showing an example of application.xml according to the first embodiment.

FIG. 16 is a flow chart showing an example of application creating processing, which is executed in an application transformation unit of the application manager according to the first embodiment.

FIG. 17 is a flow chart showing details of processing of creating a first application and a second application which is executed in Steps S42 and S43 of FIG. 16 by the application transformation unit according to the first embodiment.

FIG. 18 is a flow chart showing details of request switch creating processing, which is executed in Step S44 of FIG. 16 according to the first embodiment.

FIG. 19 is an explanatory diagram showing an example of a deployment descriptor according to the first embodiment.

FIG. 20 is a flow chart showing an example of application deploying processing, which is executed by an N deployer in Step S13 of FIG. 8 according to the first embodiment.

FIG. 21 is a block diagram of a part of a state store according to the first embodiment which shows the relation between a shared context map and a session map.

FIG. 22 is a block diagram showing function elements of a request switch according to the first embodiment.

FIG. 23 is an explanatory diagram showing an example of a processing management table of the request switch according to the first embodiment.

FIG. 24 is a flow chart showing an example of processing that is executed by a request forwarding unit of the request switch according to the first embodiment.

FIG. 25 is a flow chat showing an example of processing that is executed by a switching unit of the request switch according to the first embodiment.

FIG. 26 is a flow chat showing an example of processing that is executed by a processing status management unit of the request switch according to the first embodiment.

FIG. 27 is a block diagram showing the configuration of a replace manager according to the first embodiment.

FIG. 28 is a flow chart showing an example of processing that is executed by a replace management unit of the replace manager according to the first embodiment when interval constitutes a condition for executing the replacing (replace condition).

FIG. 29 is a flow chart showing an example of processing that is executed by the replace management unit of the replace manager according to the first embodiment when system heap constitutes the replace condition.

FIG. 30 is a block diagram showing another configuration for the request switch according to the first embodiment.

FIG. 31 is a block diagram showing functions of an application server according to a second embodiment.

FIG. 32 is a block diagram showing details of processing of an application manager according to the second embodiment.

FIG. 33 is an explanatory diagram showing an example of a deployment window in a third embodiment which is provided to an administration console by a user interface.

FIG. 34 is an explanatory diagram showing an example of a version change window, which is provided to the administration console by the user interface according to the third embodiment.

FIG. 35 is a block diagram showing the behavior of the application manager according to the third embodiment.

FIG. 36 is a flow chart showing an example of processing that is executed when an application server receives a version change instruction according to the third embodiment.

FIG. 37 is a flow chart showing an example of version change processing, which is executed by the application server according to the third embodiment.

FIG. 38 is a block diagram showing the flow of processing that is executed by the application server while the first application is run according to the first to third embodiments.

FIG. 39 is a block diagram showing the flow of processing that is executed by the application server while the second application is deployed according to the first to third embodiments.

FIG. 40 is a block diagram showing the flow of processing that is executed by the application server upon completion of a switch to the second application according to the first to third embodiments.

FIG. 41 is a block diagram showing the flow of processing that is executed by the application server after the first application is undeployed according to the first to third embodiments.

FIG. 42 is a block diagram showing the flow of processing that is executed by an application server according to a fourth embodiment.

FIG. 43 is a block diagram of a completion filter according to the fourth embodiment.

### DETAILED DESCRIPTION OF THE PREFERRED EMBODIMENTS

Embodiments of this invention will be described below with reference to the accompanying drawings.

### First Embodiment

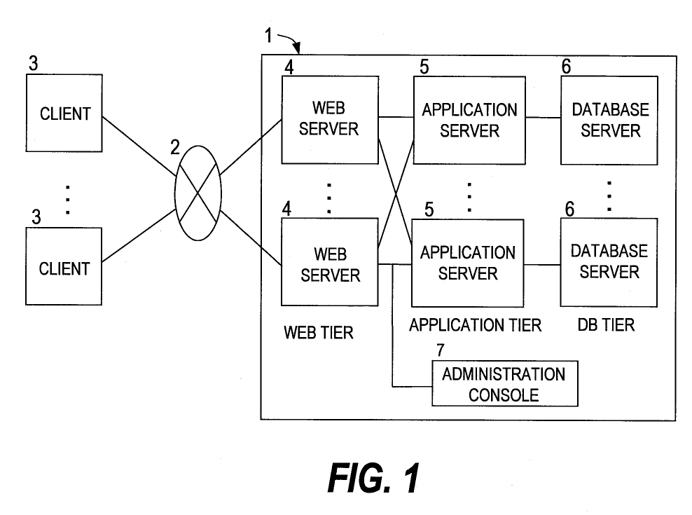

FIG. 1 is a configuration diagram of a computer system to which this invention is applied. A web site 1 which provides an application service is connected to clients 3 via a network 2. The Web site 1 receives a processing execution request from one of the clients 3, executes given processing (for example, business logic) with the use of a Web 3-tier application (a business system) composed of three tiers, a Web tier, an application tier, and a database tier, and then sends a result of executing the processing to the client 3.

At the Web tier, a plurality of Web server computers (hereinafter referred to as Web servers) 4 are disposed, which receive requests sent through HTTP from Web browsers of the clients 3. The database tier has a plurality of database server computers 6 which run a database management system (hereinafter abbreviated as DBMS) to manage data and management information. The application tier has a plurality of application server computers 5 which obtain data from the database server computers 6 in response to a processing request received by one of the Web servers 4, process the obtained data in a given way, and then send a result response to the request to the Web server 4.

Each Web server 4 has a not-shown CPU, memory, and storage system, and the same applies to each application server computer 5 and each database server computer 6. The Web servers 4, the application server computers 5, and the database server computers 6 are interconnected via a network to which an administration console 7 for controlling the servers 4 to 6 is connected. The administration console 7 has a CPU, a memory, storage system, and a display device, and is operated by an administrator to give instructions to the servers 4 to 6.

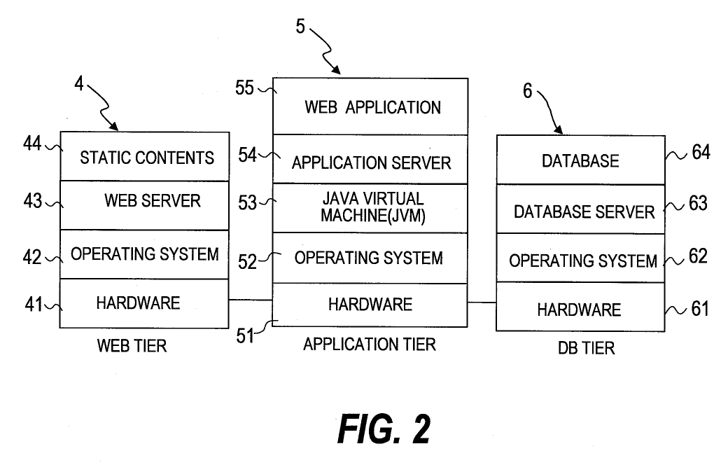

FIG. 2 is a block diagram showing software configurations at the respective tiers of the Web 3-tier application (business operation system).

In each Web server 4, an operating system (hereinafter abbreviated as OS) 42 is executed in hardware 41, which is composed of a CPU, a memory, and storage system. The OS 42 runs a Web server 43, which provides the clients 3 with static contents 44 and dynamic contents sent from the application server computers 5.

In each application server computer 5, an OS 52 is executed in hardware 51, which is composed of a CPU, a memory, and storage system. The OS 52 runs as first middleware a JAVA virtual machine 53, which in turn runs an application server 54 as second middleware. The application server 54 executes a Web application 55 that meets a processing request received by the Web server 43. The Web application 55 processes given business logic or the like, requests a database server 63, which is provided in each database server computer 6, to read and write data, performs given processing on the obtained data, and returns the result to the Web server 43. Receiving, from the application server 54, a response to the processing request, the Web server 43 sends an execution result of the processing requested by one of the clients 3 to the client 3.

In each database server computer 6, an OS 62 is executed in hardware 61, which is composed of a CPU, a memory, and storage system. The OS 62 runs the database server 63, which reads and writes data in a database 64 as requested by the Web application 55.

The Web tier, the application tier, and the database tier in the above example described with reference to FIGS. 1 and 2 are implemented by separate computers, but these three tiers may be implemented by the same computer. Alternatively, the Web tier and the application tier may be integrated. The servers 4 at the Web tier are connected to a memory or storage system that has a file system to store files and data, and the same applies to the servers 5 and 6 at the application tier and the database tier.

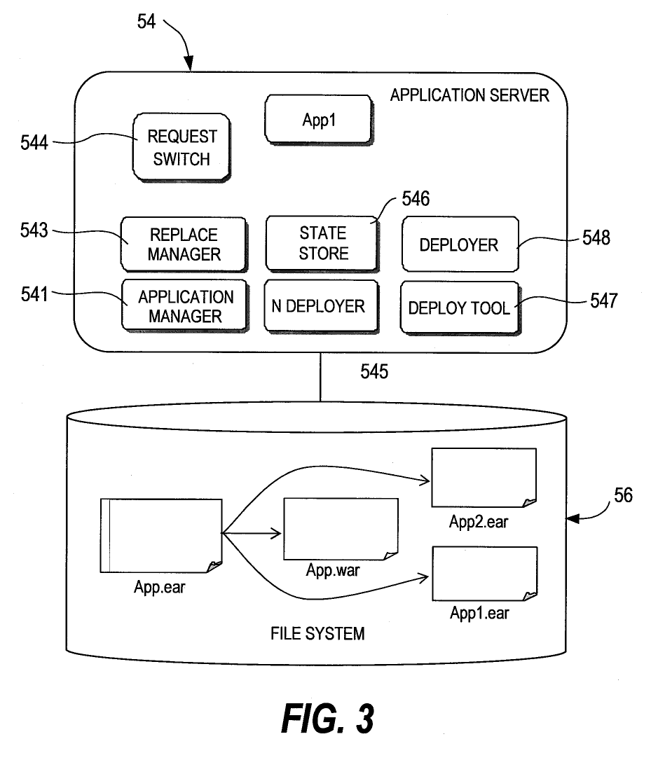

FIG. 3 is a block diagram showing functions of the application server 54. Shown in FIG. 3 is an example in which the application server 45 receives from one of the Web servers 4 a processing request to execute an application App. The application server 54 reads a Web application file App.ear out of a file system 56 of the storage system or memory connected to the application server computer 5, and creates two Web applications, App1.ear and App2.ear, from the read file App.ear. The application server 54 frees up resources by switching the active Web application from the Web application App1 to the Web application App2 in a manner described later. Because the Web applications App1 and App2 are deployed in the same application server run in the same JVM executed by the same OS, codes of the OS, the JVM, and the application server remain in the CPU cache and other caches after the Web applications are switched. This way, cache misses of the CPU are minimized and performance degradation is reduced compared to prior art, where the entirety of an application is replaced by invoking another whole application, and a failure due to resource leak is thus prevented.

Function elements of the application server 54 will be described next.

An application manager 541 creates, in the file system 56 of the memory or the storage system, from the Web application file App.ear, which is the original of the Web application 55, the active Web application App1.ear and the standby Web application App2.ear as well as a request switch 544 (App.war). The active Web application App1.ear and the standby Web application App2.ear function as the Web application 55 shown in FIG. 2. The request switch App.war functions as a request switch 544 shown in FIG. 3. The Web application 55 in the following description means the active Web application App1.ear and the standby Web application App2.ear.

The request switch 544 is created as App.war in the file system 56, and forwards requests from the Web servers 4 to the active Web application App1.ear. Upon receiving a given instruction from a replace manager 543, which will be described later, the request switch 544 executes switching processing so that requests from the Web servers 4 are forwarded to the standby Web application App2.ear instead of the active Web application App 1.ear.

A deployer 548 deploys and undeploys Web applications (App1 and App2) in the application server 54 as in prior art. When a Web application is undeployed, a memory area that has been used by the formerly deployed application is no longer occupied, and is collected through subsequent garbage collection processing of JVM to be used again.

An N deployer 545 deploys, unlike the deployer 548, active and standby Web applications in a session sharing mode in order to make the active Web application and the standby Web application share session information.

The replace manager 543 controls switching between the active Web application App1 and the standby Web application App2 as will be described later.

A deploy tool 547 provides a user interface to the administration console 7 operated by an administrator and is used for such operations as deployment of a Web application as will be described later.

A state store 546 holds the session information and the like of an application to be executed. When the active Web application App1 is replaced by the standby Web application App2, a session information that has been referred to by App1 has to be available to App2 because otherwise App2 cannot take over the processing. The state store 546 enables the active and standby Web applications to share session information in a manner described later.

In the example of FIG. 3, the active Web application App1, the standby Web application App2, and the request switch 544 are created in the file system 56 of the memory or the storage system from the original, App.ear, of one Web application 55. There is only one standby Web application App2 in the example of FIG. 3, but the application manager 541 can create a plurality of standby Web applications App2 to Appn and as many request switches (App.war) 544 as the standby Web applications App2 to Appn.

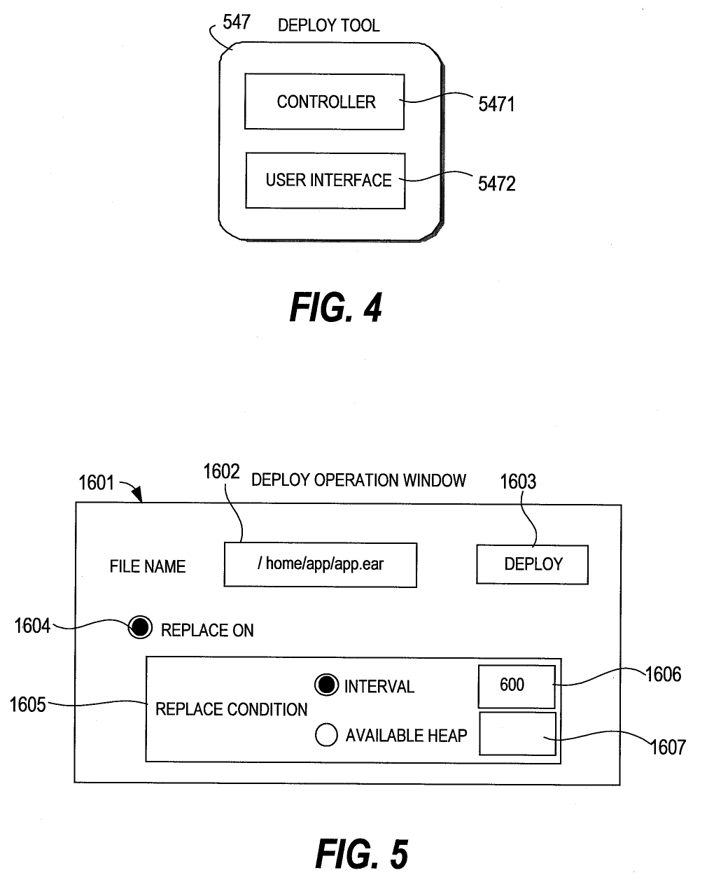

FIG. 4 is a block diagram showing an example of what function the deploy tool 547 has.

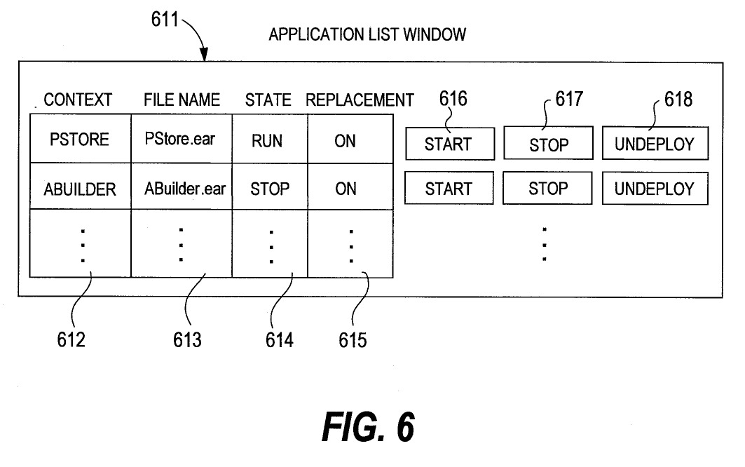

The deploy tool 547 has a user interface 5472, which provides the administration console 7 with information about a switch from one Web application 55 to another executed by the application server 54 and which receives an instruction related to the switching, and a controller 5471, which executes the instruction received by the user interface 5472. The user interface 5472 provides a deployment window and an application list window as will be described below with reference to FIGS. 5 and 6.

FIG. 5 is an explanatory diagram showing an example of a deployment operation window 1601 that is provided to the administration console 7 by the user interface 5472 of this embodiment.

As a file path 1602 in the deployment operation window 1601, the file name of the original Web application is stored. The file name is specified by a setting of an administrator or the like. A “deploy” button 1603 is used to deploy the original Web application (App.ear) specified by the file path 1602.

A replace checkbox 1604 is used to set whether to create the request switch App.war, the active Web application App1.ear, and the standby Web application App2.ear from the original application App.ear specified by the file path 1602 and to replace the active Web application App1.ear with the standby Web application App2.ear. An instruction to carry out the replacing is given by checking the replace checkbox 1604 as shown in FIG. 5. The instruction is given to the replace manager 543.

A replace condition 1605 is used to set the type of replace condition for executing a switch from the active Web application App1.ear to the standby Web application App2.ear, and a value for the replace condition. Shown in FIG. 5 is an example in which either a checkbox for input interval (measured in seconds) 1606 or a checkbox for available heap (the free capacity of a heap memory area in a JAVA® virtual machine) 1607 is checked and a value is entered in an input field for the checked replace condition. In the example of FIG. 5, “interval” (time interval) is chosen as the type of replace condition and a value “600 seconds” is set. The set values are stored in the replace manager 543, which will be described later, and, when 600 seconds elapse because the execution of the active Web application App1.ear is started, the standby Web application App2.ear replaces App1.ear as the Web application 55 in a manner described later. Other replace conditions than “interval” and “available heap” may be employed.

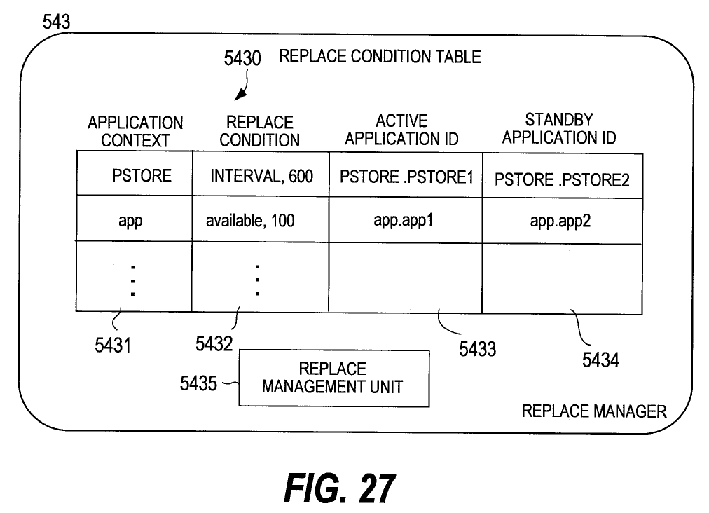

Settings set in the deployment operation window 1601 are stored in a replace condition table 5430 of the replace manager 543 which is shown in FIG. 27.

FIG. 6 is an explanatory diagram showing an example of an application list window 611, which is provided to the administration console 7 by the user interface 5472. The application list window 611 displayed on the administration console 7 displays the state of the Web application 55 that is currently operable by the application server 54, and is used to control the start, stop, and undeployment of the operable Web application 55.

The application list window 611 displays as a context 612 the context name of an application specified by the file path 1602. As a file name 613, the file name of an application specified by the file path 1602 is displayed along with the extension.

As a state 614, an application execution state is displayed and “run” indicates that the application is being executed whereas “stop” indicates that the application is not in operation.

As a replacement state 615, “on” indicates that an active Web application is going to be replaced by a standby Web application whereas “off” indicates that the replacing is not executed. A “start” button 616 is used to give an instruction to start the Web application 55 that is deployed in the memory, and a “stop” button 617 is used to give an instruction to stop the Web application 55 that is being executed. An “undeploy” button 618 is used to undeploy the Web application 55 that is no longer in operation from the memory.

The context 612, the file name 613, the state 614, and the replacement state 615 are settings information and execution information which are recorded in the controller 5471 to be provided to the user interface 5472.

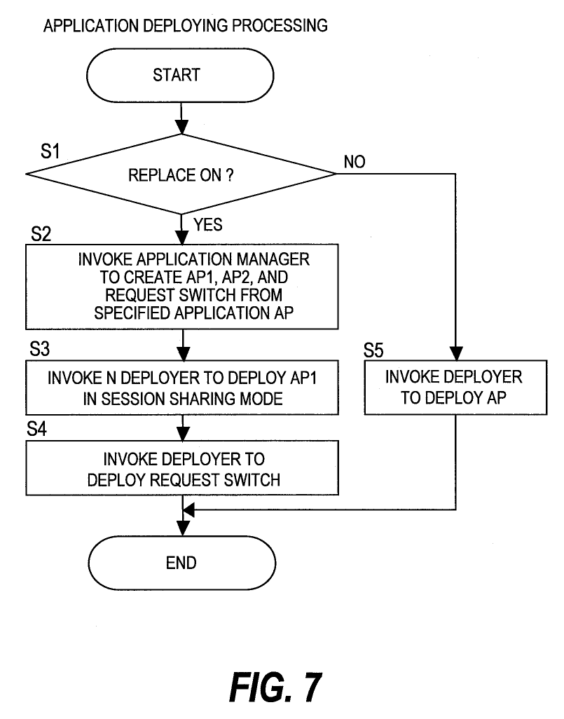

FIG. 7 is a flow chart showing an example of deploy processing, which is executed by the controller 5471 of the deploy tool 547.

This processing is executed when an administrator or the like enters the file path 1602 and other settings and then clicks on the deploy button 1603 in the deployment operation window 1601 of FIG. 5 displayed on the administration console 7.

In Step S1, the controller 5471 judges whether the replace checkbox 1604 is checked or not. The controller 5471 proceeds to Step S2 when the replace checkbox 1604 is checked, and to Step S5 when the replace checkbox 1604 is not checked.

In Step S2, the controller 5471 invokes the application manager 541 to read the Web application App.ear, which is the original of the Web application 55 whose file name has been entered as the file path 1602 in the deployment operation window 1601, and to create the active Web application App1.ear, the standby Web application App2.ear, and the request switch App.war. How the applications and the request switch are created will be described later.

In Step S3, the controller 5471 invokes the N deployer 545 to deploy the created active Web application App1.ear in the memory. The N deployer 545 deploys the active Web application App1.ear in the memory in a session sharing mode. The session sharing mode is a mode that allows the active Web application App1.ear and the standby Web application App2.ear to share session information.

In Step S4, the controller 5471 has the deployer 548 deploy the created request switch App.war in the memory, and ends the processing.

When it is judged in Step S1 that the replace checkbox 1604 is not checked, then in Step S5, the Web application 55 is executed alone by invoking the deployer 548 with the controller 5471 and deploying the execution application App.ear, which is the original of the Web application 55.

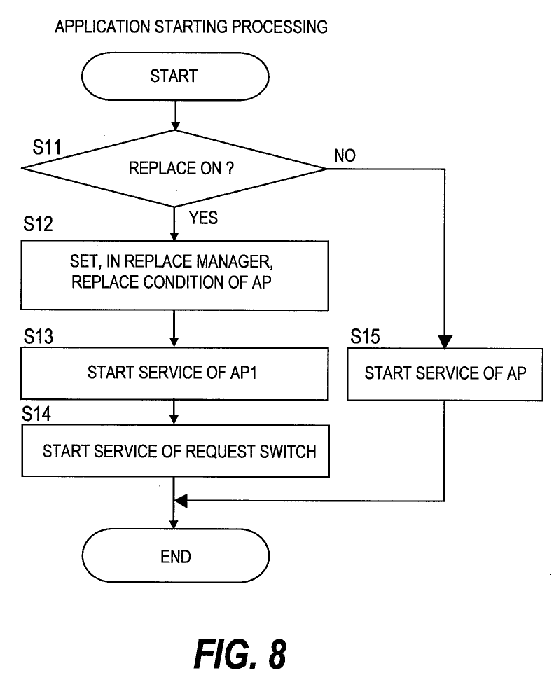

FIG. 8 is a flow chart showing an example of application starting processing, which is executed by the controller 5471 of the deploy tool 547.

This processing is executed when the administrator clicks on one of the start buttons 616 that is associated with the chosen context 612 in the application list window 611 of FIG. 6 displayed on the administration console 7.

In Step S11, the controller 5471 checks whether or not the replace checkbox 1604 is checked in the deployment operation window 1601 of FIG. 5. The controller 5471 proceeds to Step S12 when the replace checkbox 1604 is checked, and to Step S15 when the replace checkbox 1604 is not checked.

In Step S12, the controller 5471 sets the replace condition 1605 in the replace manager 543 according to settings information of the Web application 55 (the application App1.ear) that is associated with the start button 616 operated in the application list window 611 of FIG. 6. The replace manager 543 sets this replace condition 1605 in association with the Web application 55 (the application App.ear) that is to be replaced.

In Step S13, the controller 5471 gives an instruction to start the active Web application App1.ear to start a service provided by the active Web application App1.ear.

In Step S14, the controller 5471 gives an instruction to start the request switch App.war to start a service provided by the request switch App.war.

When it is judged in Step S11 that the replace checkbox 1604 has not been checked in the deployment operation window 1601 upon setting of deployment settings for the application, the controller 5471 proceeds to Step S15 to start a service provided by the application App.ear.

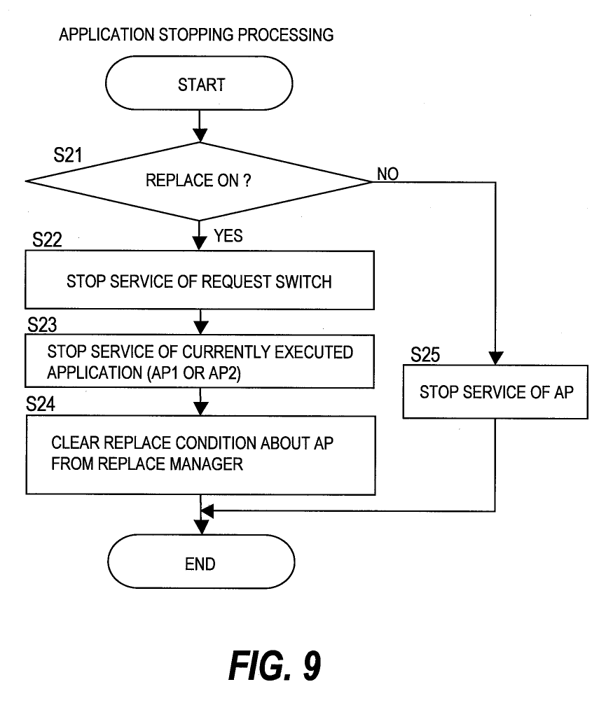

FIG. 9 is a flow chart showing an example of application stopping processing, which is executed by the controller 5471 of the deploy tool 547.

This processing is executed when the administrator clicks on one of the stop buttons 612 that is associated with the chosen context 612 in the application list window 611 of FIG. 6 displayed on the administration console 7.

In Step S21, the controller 5471 checks whether or not the replace checkbox 1604 is checked in the deployment operation window 1601. The controller 5471 proceeds to Step S22 when the replace checkbox 1604 is checked, and to Step S25 when the replace checkbox 1604 is not checked.

In Step S22, the controller 5471 stops the service of the request switch App.war of the application that is associated with the operated stop button 617 (here, the active Web application App1.ear). In other words, the request switch App.war stops forwarding requests from the Web servers 4.

In Step S23, the controller 5471 stops the service of the active Web application App1.ear or App2.ear (the standby Web application App2.ear serves as the active application and the active Web application App1.ear serves as the standby application after the replacing takes place) that is associated with the request switch App.war stopped in Step S22 and that is currently executed or deployed in the memory.

In Step S24, the controller 5471 clears the replace condition in the replace manager 543.

In Step S25, which is reached from Step S21 as a result of the replace checkbox 1604 being judged in Step S21 as unchecked, the controller 5471 gives an instruction to stop the execution application App.ear.

Through the above processing, the controller 5471 first stops the service of the request switch App.war to suspend forwarding of requests and then instructs the Web application 55 (App1.ear or App2.ear) that is being executed to stop its service.

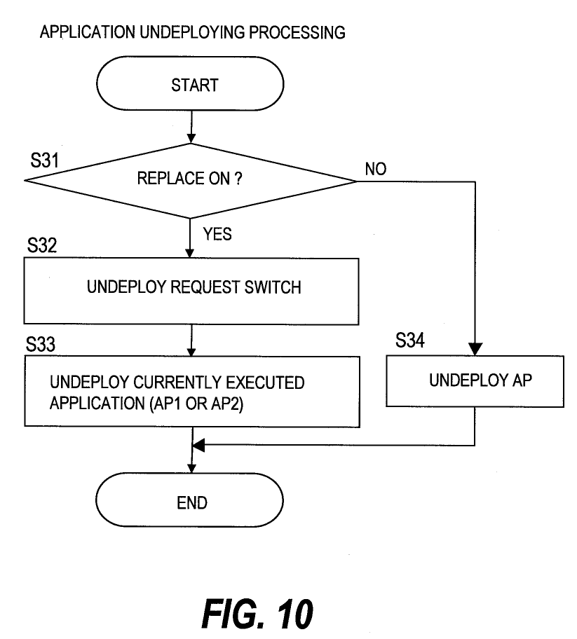

FIG. 10 is a flow chart showing an example of application undeploying processing, which is executed by the controller 5471 of the deploy tool 547.

This processing is executed when the administrator clicks on one of the undeploy buttons 618 that is associated with the chosen context 612 in the application list window 611 of FIG. 6 displayed on the administration console 7.

In Step S31, the controller 5471 judges whether or not the replace checkbox 1604 has been checked when deploy settings for the Web application 55 have been set in the deployment operation window 1601. The controller 5471 proceeds to Step S32 when the replace checkbox 1604 is checked, and to Step S34 when the replace checkbox 1604 is not checked.

In Step S32, the controller 5471 instructs the deployer 548 to undeploy the request switch App.war (free up a memory space occupied by the request switch App.war).

In Step S33, the controller 5471 instructs the N deployer 545 to undeploy the active Web application App1 or App2 that is associated with the request switch App.war undeployed in Step S32 and that is currently executed or deployed.

When it is judged in Step S31 that the replace checkbox 1604 is not checked, the controller 5471 proceeds to Step S34 and gives an instruction to undeploy the execution application App.ear, to thereby free up a memory space occupied by the application App.ear.

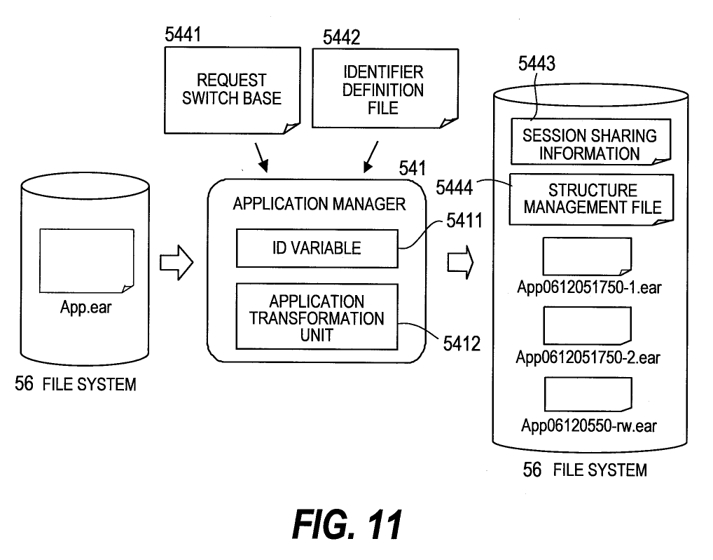

FIG. 11 is a block diagram showing details of the processing that is executed by the application manager 541 in Step S2 of FIG. 7.

The application manager 541 has an application transformation unit 5412 and an ID variable obtaining unit 5411. The application transformation unit 5412 creates the active Web application App1.ear, the standby Web application App2.ear, and the request switch App.war from the application App that is identified by the application file name 1602 specified by the administrator in the deployment operation window 1601. The ID variable obtaining unit 5411 obtains an ID variable for converting the application name of the active Web application, the standby Web application, and the request switch.

When the application transformation unit 5412 receives an invoke instruction from the controller 5471 of the deploy tool 547, the application manager 541 obtains from the file system 56 the application App.ear to be replaced, and reads a request switch base 5441 and an identifier definition file 5442 which are set in advance. The file system 56 is a storage system area set in the storage system or memory of the application server computer 5.

The ID variable obtaining unit 5411 obtains a given ID variable which serves as a name for the active Web application, the standby Web application, and the request switch instead of the name (file name) of the execution application. The ID variable set as a name in this embodiment is a time stamp that is recorded when the execution application App.ear is read and obtained in a given format (for example, “YYMMDDHHMM”=year, month, day, hour, minute).

The application transformation unit 5412 sets the names of the active Web application, the standby Web application, and the request switch based on the read identifier definition file 5442 and the obtained ID variable. Shown in FIG. 11 is an example in which “-1” is attached in the case of the active Web application, “-2” is attached in the case of the standby Web application, and “-rs” is attached to the context name (or file name) of the request switch 544.

In the example of FIG. 11, a year, month, day, hour, and minute “YYMMDDHH” at which the execution application App.ear is read out of the file system 56 is set as the ID variable obtained by the ID variable obtaining unit 5411, and the application transformation unit 5412 converts the name of the application into “AppYYMMDDHH-X” by attaching the obtained ID variable and a suffix that is determined from the identifier definition file 5442 to the application's file name “App”. The application transformation unit 5412 does not change the extensions of the active and standby Web applications and the request switch, and the Web applications keep their extension “.ear” while the request switch keeps its extension “.war”.

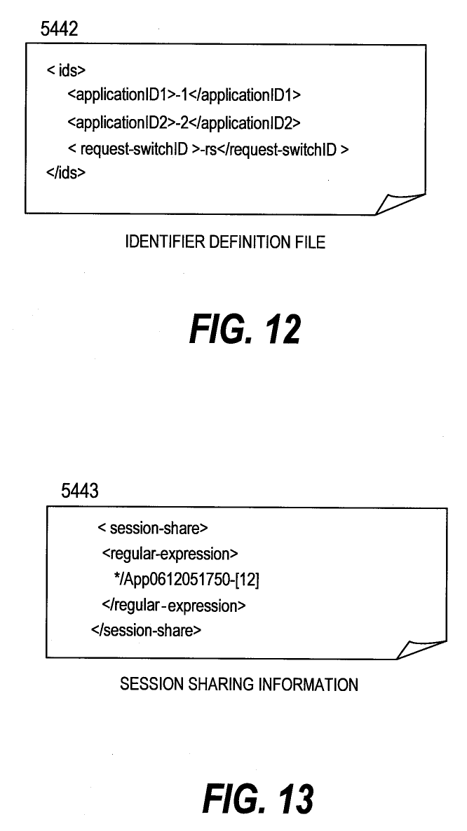

FIG. 12 shows an example of the identifier definition file 5442.

According to definitions of the identifier definition file 5442 in the example of FIG. 12, the ID variable and a first identifier “-1” are attached in the case of the active Web application, the ID variable and a second identifier “-2” are attached in the case of the standby Web identifier, and the ID variable and a given identifier “-RS” are attached in the case of the request switch.

The application manager 541 thus sets as the ID variable a time at which the original execution application, “App.ear”, is designated in FIG. 11 (for example, “0612051750”), and sets the name of the active Web application as “App0612051750-1.ear”, the name of the standby Web application as “App0612051750-2.ear”, and the name of the request switch as “App0612051750-rs.war”.

The active Web application App0612051750-1.ear and the standby Web application App0612051750-2.ear, which are programs of the same function but have different file names and different context names, can be executed in parallel in the application server 54.

The request switch App0612051750-rs.war has the program of the request switch base 5441 as a base to which a description for switching the destination of requests sent by the Web servers 4 from the active Web application App0612051750-1.ear to the standby Web application App0612051750-2.ear is attached.

After creating the active Web application, the standby Web application, and the request switch, the application manager 541 creates, in the file system 56, sharing information 5443, which is settings about session information shared between the active Web application and the standby Web application, and a structure management file 5444, which shows the structures of the active Web application, standby Web application, and request switch created from the application “App.ea”.

The session sharing information 5443 is, as shown in FIG. 13, uses a regular expression, for example, XML, and describes that the suffixes “-1” and “-2” to “App0612051750” are to be treated equally.

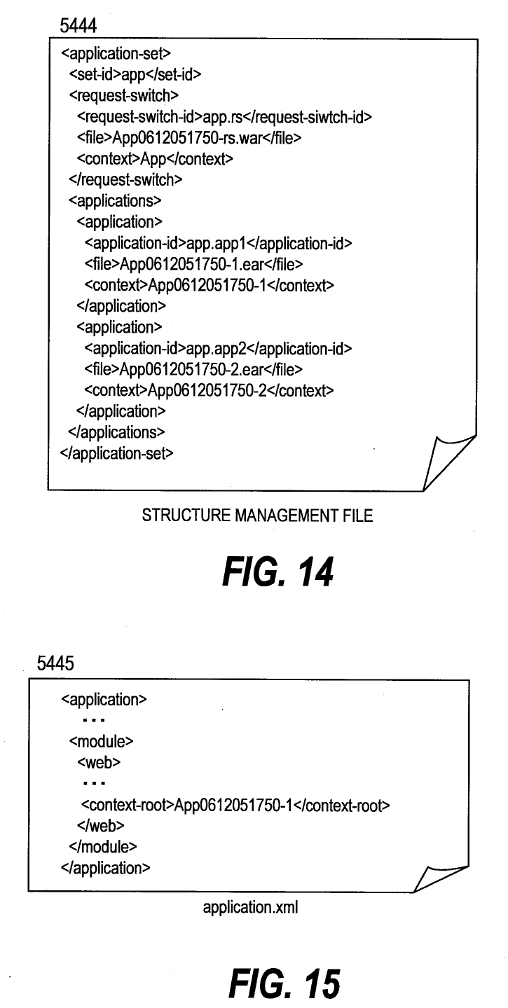

The structure management file 5444 is, as shown in FIG. 14, written in XML or the like and shows that: the request switch has a file name “App0612051750-rs.war” and a context name “App”; the active Web application has a file name “App0612051750-1.ear” and a context name “App0612051750-1”; and the standby Web application has a file name “App0612051750-2.ear” and a context name “App0612051750-2”.

An application file that has a file extension “ear” is constructed by packaging a deployment descriptor group which describes various types of settings information related to the application and a program group which describes given processing. A deployment descriptor is written in XML or the like and, for example, “application.xml” 5445 shown in FIG. 15 is a deployment descriptor. In the tag portion, <context-root>, of the “application.xml” 5445 in FIG. 15, the context name of the application is written. The “application.xml” 5445 in this example is an example of a deployment descriptor of the first application (active Web application) file App0612051750-1.ear, and its context name is set to “App0612051750-1”.

When the file of an original application is designated, the application manager 541 opens the file package, breaks up the package into a deployment descriptor group constituted of such descriptors as “application.xml” and a program group, writes the identifier of the first application (e.g., “App0612051750-1”) in the <context-root> tag of “application.xml”, and packages the descriptor and the program group together, thereby creating the first application file App0612051750-1.ear.

In a similar fashion, the application manager 541 creates the second application (standby web application) by writing the context name of the second application in the <context-root> tag of “application.xml” and packaging the descriptor and the program group together.

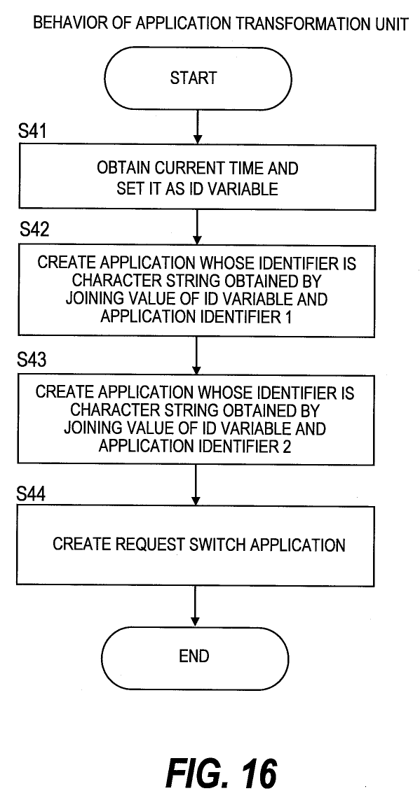

FIG. 16 is a flow chart showing an example of application creating processing, which is executed by the application transformation unit 5412 of the application manager 541.

Upon reading the original application App.ear out of the file system 56, the application manager 541 first obtains the current time and sets the obtained value as the ID variable in Step S41. The ID variable in this embodiment is date and time but may be other values as long as it does not give the same name to different applications and allows unique identification of an application.

In Step S42, the first application (active Web application) is created by attaching the value of the ID variable and the first identifier “-1” read out of the identifier definition file 5442 to the name of the execution application App.ear, “App”.

In Step S43, the second application (standby Web application) is created in a similar fashion by attaching the value of the ID variable and the second identifier “-2” read out of the identifier definition file 5442 to the name of the execution application.

In Step S44, a file is created as the request switch by adding the names of the first and second applications to the request switch base 5441, and is given a name by attaching the value of the ID variable and the given identifier “-RS”, which is read out of the identifier definition file 5442, in a manner similar to Steps S42 and S43. The application transformation unit 5412 stores information of the request switch in the structure management file 5444, and sets the identifiers of the first and second applications.

Through the above processing, the active Web application, the standby Web application, and the request switch are created.

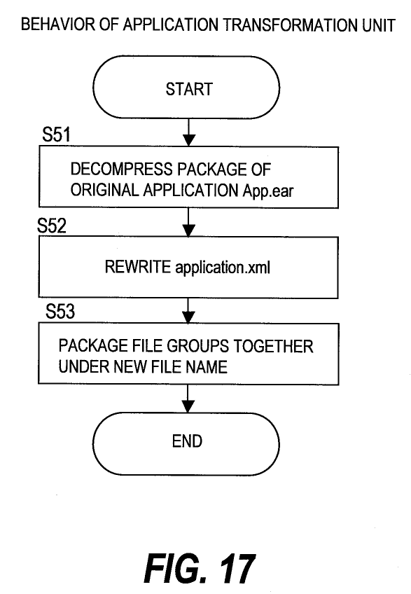

FIG. 17 is a flow chart showing details of the processing of creating the first and second applications which is executed in Steps S42 and S43 of FIG. 16 by the application transformation unit 5412.

The application transformation unit 5412 reads the original application file App.ear and, in Step S51, decompresses the file package to take a deployment descriptor group and a program group out of the package.

In Step S52, the application transformation unit 5412 sets a character string that is obtained by joining the context name of the original application, the value of the ID variable, and the identifier of the first application in <context-root> of “application.xml”, which is one of the deployment descriptors in the deployment descriptor group. In Step S53, the application transformation unit 5412 packages the updated deployment descriptor group and the program group together to create the first application file App0612051750-1.ear.

The application transformation unit 5412 then creates the second application in a manner similar to this processing.

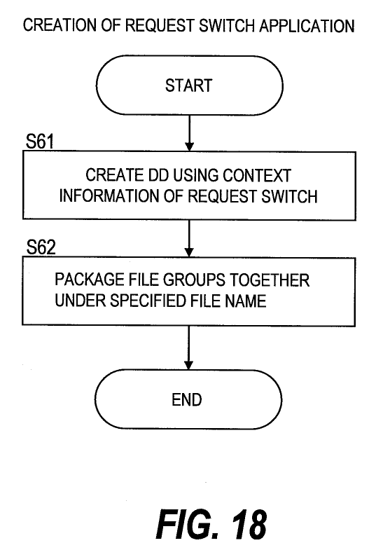

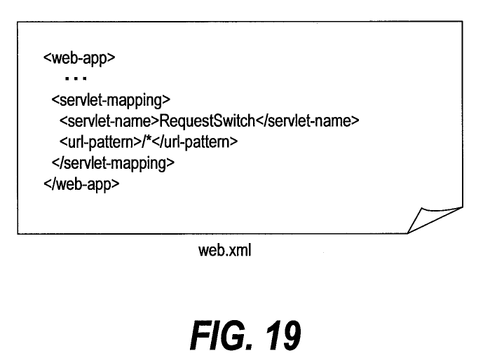

FIG. 18 is a flow chart showing details of the request switch creating processing which is executed in Step S44 of FIG. 16. In Step S61, the application transformation unit 5412 looks up the structure management file 5444 for the context name of the request switch, and creates a deployment descriptor for the request switch by setting the retrieved context name in <context-root> of a deployment descriptor base. A deployment descriptor for a war file is web.xml. “/*” is set in the <url-pattern> tag of a web.xml base as shown in FIG. 19, and indicates that all requests from the client are accepted.

In Step S62, the request switch base 5441 and the created deployment descriptor are packaged together to package a request switch file, whose file name is created from the ID variable value obtained in FIG. 16 and the given identifier read out of the identifier definition file 5442. The created request switch file is, for example, App0612051750-RS.war.

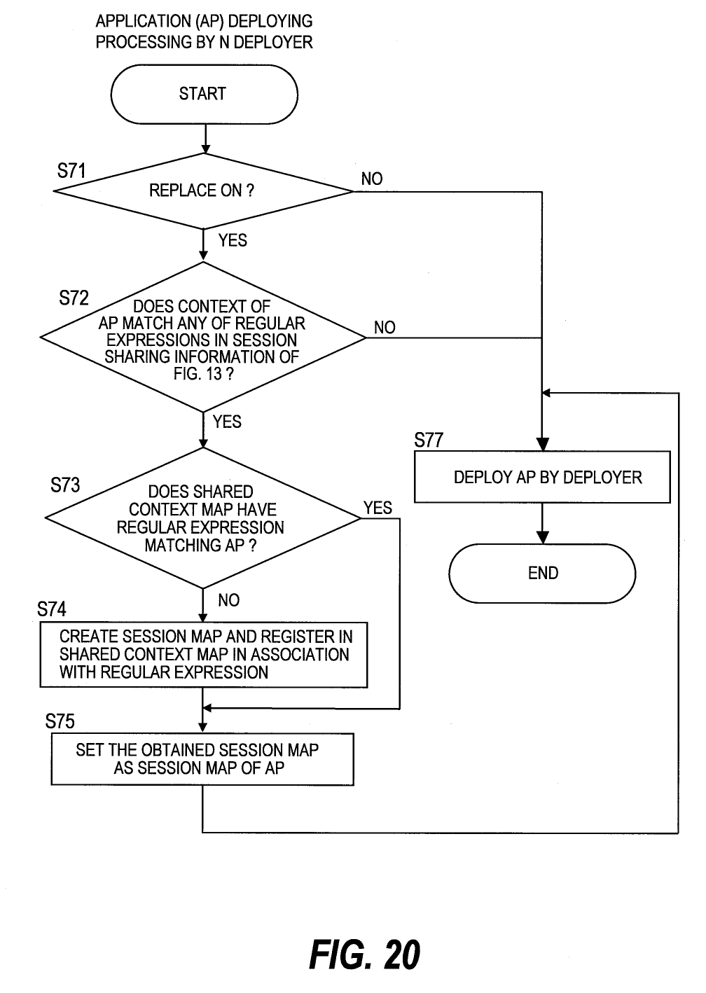

FIG. 20 is a flow chart showing an example of the application deploying processing, which is executed by the N deployer 545 in Step S3 of FIG. 7.

In Step S71, the N deployer 545 judges whether or not the operator of the administration console 7 has checked the replace checkbox 1604 in the deployment operation window 1601 in setting Web application deployment settings. The N deployer 545 proceeds to Step S72 when the replacement is to be carried out, and to Step S77 when the replacement is not to be executed.

In Step S72, the N deployer 545 judges whether or not any of the regular expressions written in the session sharing information 5443 of FIG. 13 matches context information of a designated active or standby Web application. When there is a mach, the N deployer 545 proceeds to Step S73 where session information is shared between the active Web application and the standby Web application. When there is no match, the N deployer 545 moves to Step S77 skipping sharing of session information.

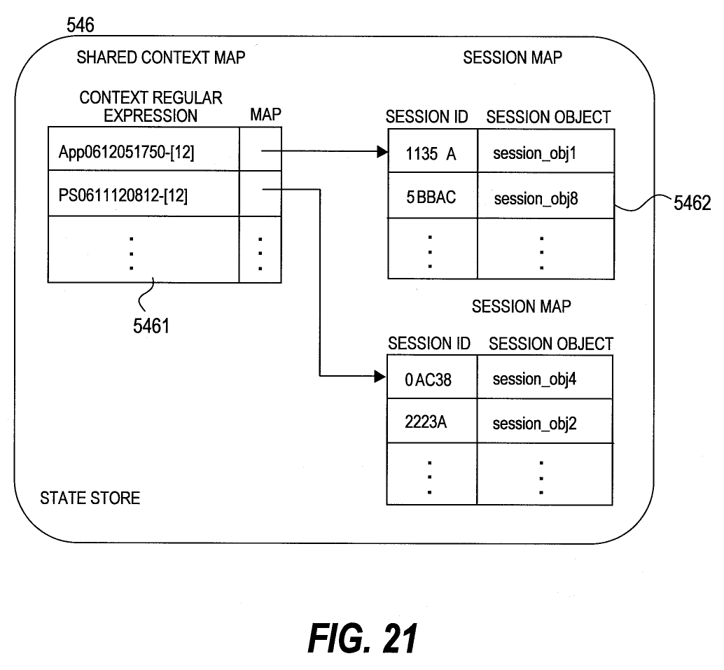

In Step S73, the N deployer 545 judges whether or not context information of the designated Web application has already been registered in a shared context map 5461 shown in FIG. 21. The N deployer 545 makes a judgment by judging whether or not a context regular expression that matches the context information of the designated application is found in the shared context map 5461. When the matching context regular expression is not found in the shared context map 5461, the N deployer 545 proceeds to Step S74.

In Step S74, a new session map 5462 is created within the state store 546 to register a pair consisting of the context name and the created session map 5462 in the shared context map 5461, and to set the created session map 5462 as a session map of the designated Web application.

In the case where the context name of the designated Web application is found to have been registered in the shared context map 5461 in Step S73, the N deployer 545 proceeds to Step S75, where the session map 5462 that is associated with the registered context name is set as a session map of the designated Web application.

Lastly, in Step S77, the N deployer 545 has the deployer 548 deploy the file of the designated Web application (for example, App0612051750-1.ear) in the memory.

The N deployer 545 deploys a Web application in the memory through the above processing. The active Web application is deployed in the memory by the N deployer 548 called up by a Web application deployment instruction which the operator of the administration console 7 enters through the deployment operation window 1601 of FIG. 5. The standby Web application is deployed in the memory by the N deployer 545 upon reception of an instruction from a replace management unit 5435 of the replace manager 543 as will be described later.

FIG. 21 is a block diagram of a part of a content of the state store 546, and shows the relation between the shared context map 5461 and the session maps 5462 which are stored in the state store 546.

The shared context map 5461 is a table in which a regular expression of the context name of a Web application is paired with a pointer to the session map 5462 that is associated with this regular expression of the context name and holds session information. Each session map 5462 is a map in which a session ID is paired with a pointer to a session object that is associated with this session ID.

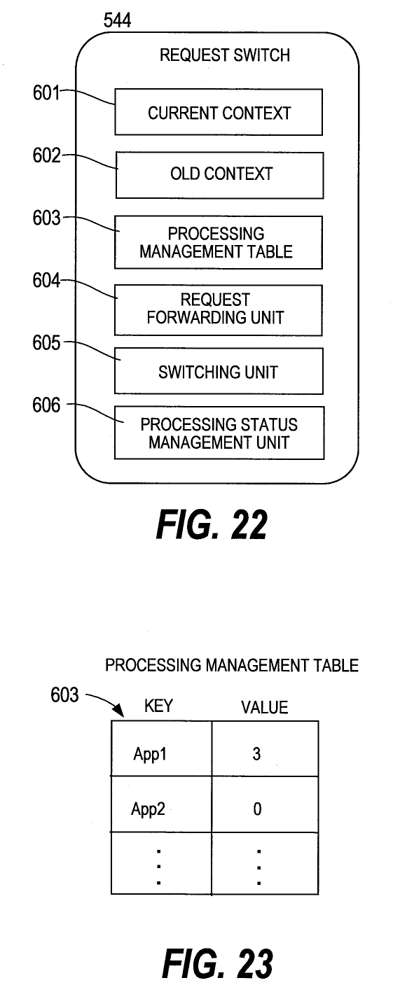

FIG. 22 is a block diagram showing function elements of the request switch 544.

The request switch 544 is deployed in the memory as, for example, the file App0612051750-rs.war in the manner described above, and forwards requests sent from the Web servers 4 to the Web application 55. When the standby Web application replaces the active Web application as the Web application 55, the request switch 544 switches the forwarding destination of the requests to the standby Web application from the active Web application.

The request switch 544 is therefore composed of a current context 601 for storing the context name of a Web application to which the requests are forwarded, an old context 602 for storing the context name of an Web application that has been the active Web application prior to the switching, a processing management table 603 for managing how many requests are currently being processed by an Web application, a request forwarding unit 604 for forwarding requests sent by the Web servers 4 to the active Web application, a switching unit 605 for switching the destination to which the requests are forwarded by interchanging the current context 601 and the old context 602 with each other, and a processing status management unit 606 for judging whether or not a Web application whose context name is stored as the old context 602 has completed processing. Details of the components of the request switch 544 will be described below.

FIG. 23 is an explanatory diagram showing an example of the processing management table 603 of the request switch 544. The processing management table 603 has two fields, one of which is a key field for storing the identifier of the Web application 55 to which the request switch 544 forwards requests, and the other is a value field for storing the number of requests that are being processed. A context name or the like can be set as the identifier of the Web application 55 in the key field.

The processing management table 603 is managed mainly by the request forwarding unit 604. When a processing request from one of the Web servers 4 is forwarded to the Web application 55, the request forwarding unit 604 increments, by 1, a value written in the value field of a record entry that has the identifier of this Web application 55 and, when this Web application 55 finishes processing the processing request, the request forwarding unit 604 decrements the value written in the value field by 1. In other words, a positive integer written in the value field of a record entry indicates that the Web application 55 that is identified by an identifier written in the key field of the same record entry is executing processing.

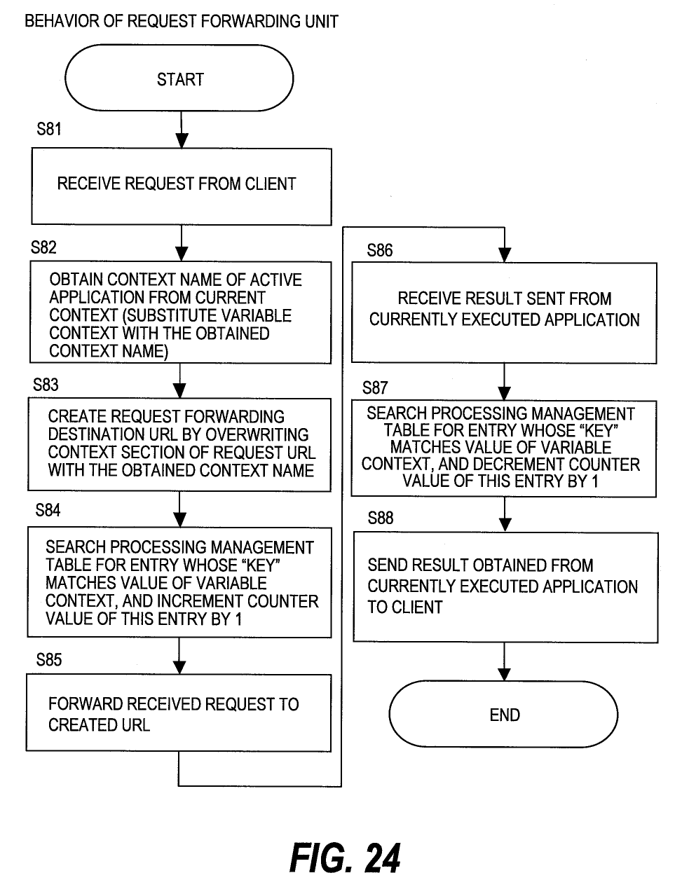

FIG. 24 is a flow chart showing an example of processing that is executed by the request forwarding unit 604 of the request switch 544. This processing is invoked each time a processing request is received from one of the Web servers 4.

In Step S81, the request switch 544 receives a processing request from one of the Web servers 4 and starts to process the processing request in the request forwarding unit 604. In Step S82, the request forwarding unit 604 obtains, from the current context 601, the context name of the Web application that is in operation, and substitutes a variable context with the obtained context name.

In Step S83, the request forwarding unit 604 overwrites the context portion of a request URL contained in the processing request that has been received from the Web server 4 with the context name (=the value of the variable context) obtained in Step S82, thereby creating the URL of the request forwarding destination.

In Step S84, the request forwarding unit 604 searches the processing management table 603 for a record entry whose key field value matches the value of the variable context, and increments, by 1, a value written in the value field of this record entry. In Step S85, the request forwarding unit 604 forwards the processing request received from the Web server 4 to the URL changed in Step S83. In other words, the processing request is forwarded to the Web application 55 that is specified by the current context 601.

The request forwarding unit 604 next receives in Step S86 a result of processing the processing request from the Web application 55 to which the processing request has been forwarded. In Step S87, the request forwarding unit 604 searches the processing management table 603 for a record entry whose key field value matches the context name stored as the variable context, and decrements, by 1, a value written in the value field of this record entry.

In Step S88, the request forwarding unit 604 sends, to the client, via the Web server 4, the result of processing the processing request which has been obtained from the Web application 55 that is in operation.

Through the above processing, requests from the Web servers 4 are forwarded to the Web application 55 that is set as the current context 1, and the processing management table 603 is updated accordingly.

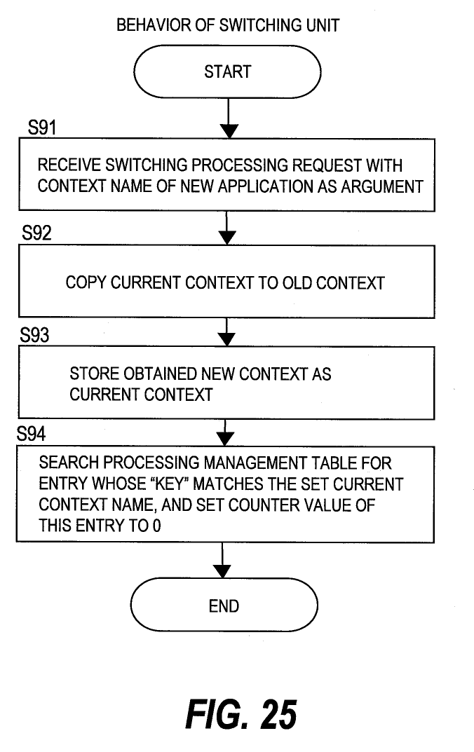

FIG. 25 is a flow chart showing an example of processing that is executed by the switching unit 605 of the request switch 544. The request forwarding unit 604 invokes the switching unit 605 upon receiving from the replace manager 543 a request to execute processing of switching the Web application 55 from the active Web application to the standby Web application.

In Step S91, the switching unit 605 receives a request to execute switching processing from the replace manager 543, and obtains the context name of the standby Web application which is contained in an argument of the received processing request.

In Step S92, the switching unit 605 copies the context name stored as the current context 601 to the old context 602. In Step S93, the switching unit 605 stores as the current context 601 the context name of the standby Web application which has been obtained from the replace manager 543.

In Step S94, the switching unit 605 searches the processing management table 603 for a record entry whose key field value matches the current context 601, and writes 0 in the value field of this record entry.

Through the above processing, the forwarding destination of requests sent by the Web servers 4 is switched from the active Web application to the standby Web application, and the standby Web application takes over processing of the requests.

For instance, when the context name of the active Web application App1.ear is “App0612051750-1” and the context name of the standby Web application App2.ear is “App0612051750-2”, the current context 601 in the initial state is “App0612051750-1” whereas the old context 602 has no value because there is no application whose context name is to be registered as the old context 602 in the initial state. In this state, the request forwarding unit 604 forwards a processing request to the Web application that has the context name “App0612051750-1”. The replace manager 543 then requests switching processing with the context name of the standby Web application App2.ear, “App0612051750-2”, as an argument. Receiving the request, the switching unit 605 copies the value “App0612051750-1” of the current context 601 to the old context 602, and sets the context name “App0612051750-2” as the current context 601. This makes the request forwarding unit 604 forward requests that are sent by the Web servers 4 from then on to the Web application that has the context name “App0612051750-2”, namely, the standby Web application.

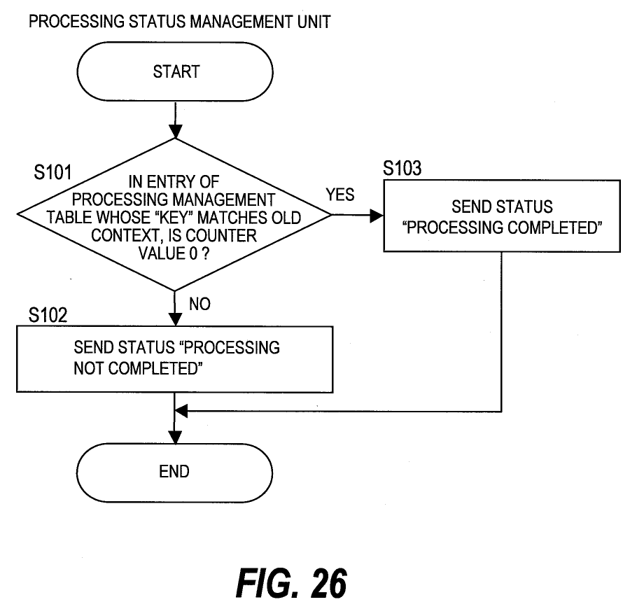

FIG. 26 is a flow chart showing an example of processing that is executed by the processing status management unit 606 of the request switch 544. The processing status management unit 606 is invoked when the replace manager 543 checks whether a Web application has finished processing a request.

In Step S101, the processing status management unit 606 judges whether or not the processing management table 603 has a record entry whose key field value matches the old context 602 and whose value field holds 0 (0 written in the value field indicates that the Web application has finished processing all requests). When the value field of this record entry holds 0, it means that the Web application 55 whose context name is registered as the old context 602 has finished processing all of requests forwarded thereto, and the processing status management unit 606 sends a status “processing completed” in response. On the other hand, when the value field of the found record entry holds other values than 0, it means that the Web application 55 whose context name is registered as the old context 602 has not finished some of requests forwarded, and the processing status management unit 606 sends a status “processing not completed” in response.

FIG. 27 is a block diagram showing the configuration of the replace manager 543, which gives an instruction to switch Web applications from active to standby when a given condition is met.

The replace manager 543 is composed of, among others, a replace condition table 5430 for storing a condition for replacing one Web application 55 with another which is set through the administration console 7, and the replace management unit 5435, which gives an instruction to replace the active Web application with the standby Web application.

The replace condition table 5430 has an application context 5431, which stores the context name of the Web application 55, a replace condition 5432, which stores a condition for executing the replacing, an active application ID 5433, which stores the ID of the active Web application, and a standby application ID 5434, which stores the ID of the standby Web application.

Stored as the replace condition 5432 are a condition type such as “time interval” or “available heap” shown in the deployment operation window 1601 of FIG. 5 and the length of the interval, when the chosen condition type is “interval”, or the byte count of the available heap, when “available heap” is chosen. In the example of FIG. 27, the replace condition 5432 for a Web application whose context name is “app” shows that the Web application is replaced when the available heap becomes smaller than 100 MB. The active and standby Web application IDs 5433 and 5434 indicate character strings written in <application-id> tags in the structure management file 5444 of FIG. 14. In this example, “app.app1” is registered as the active Web application ID 5433, indicating a Web application that is described in the structure management file 5444, specifically, a Web application that has a file name “app0612051750-1.ear” and a context name “app0612051750-1”. Registered as the standby application ID 5434 in this example is “app.app2”, which indicates a Web application that is described in the structure management file 5444, specifically, a Web application that has a file name “app0612051750-2.ear” and a context name “app0612051750-2”. The replace management unit 5435 monitors the replace condition 5432 for each application context 5431 and, when the replace condition 5432 is met, carries out the replacing of the Web application 55.

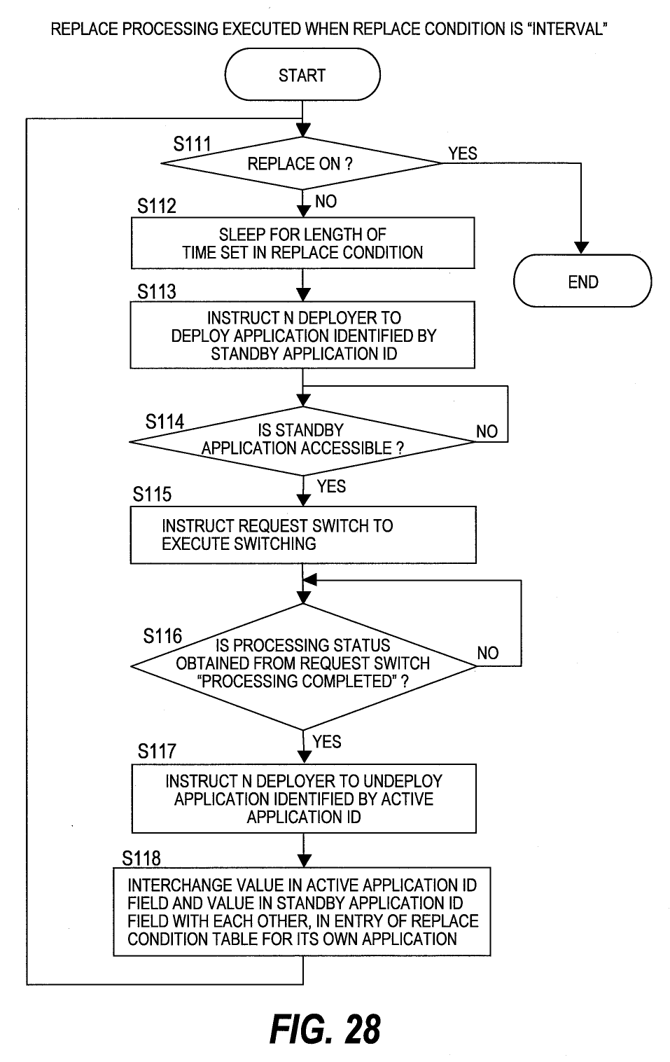

FIG. 28 is a flow chart showing an example of processing that is executed by the replace management unit 5435 of the replace manager 543 when the replace condition 5432 is “interval”. This processing is invoked for each record entry of the replace condition table 5430.

In Step S111, the replace management unit 5435 reads the replacement state 615 in the application list window 611 of FIG. 6, namely, a setting about whether to replace the Web application in question. The replace management unit 5435 proceeds to Step S112 when the Web application is to be replaced, and ends the processing when the Web application is not to be replaced.

In Step S112, the replace management unit 5435 enters a sleep state for a period set as the length of the interval in the replace condition table 5430 and, after the set period of time elapses, moves on to Step S113. In Step S113, the replace management unit 5435 instructs the N deployer 545 to deploy a Web application that is identified by the standby Web application ID 5434 of the replace condition table 5430.

In Step S114, the replace management unit 5435 judges whether or not the standby Web application instructed to be deployed is accessible and, if the Web application is not accessible yet, waits until the N deployer 545 finishes deploying the Web application and a service provided by the Web application becomes available. When the standby Web application becomes accessible, the replace management unit 5435 proceeds to Step S115.

In Step S115, the replace management unit 5435 instructs, with the application context 5431 as an argument, the request switch 544 to switch the forwarding destination of requests sent by the client from the active Web application to the standby Web application.

In Step S116, the replace management unit 5435 uses the request switch 544 to judge whether or not the application to be undeployed (the active Web application) has finished processing. Specifically, the replace management unit 5435 calls up the processing status management unit 606 of the request switch 544 shown in FIG. 22 to have the processing status management unit 606 check whether or not the active Web application has finished processing all requests as shown in FIG. 26. When the processing status management unit 606 sends a status “processing completed” in response, the replace management unit 5435 moves on to Step S117 and, when a status “processing not completed” is received, the replace management unit 5435 repeats Step S116. Thus, Step S117 is not executed until the active Web application finishes processing all requests. In Step S117, the replace management unit 5435 instructs the N deployer 545 to undeploy an application that is identified by the active Web application ID 5433 of the replace condition table 5430.

In Step S118, the replace management unit 5435 interchanges a value in the field for the active Web application ID 5433 with a value in the field for the standby Web application ID 5434.

Through the above processing, each time a set interval elapses, the replace management unit 5435 makes sure that the standby Web application is deployed, then instructs the request switch 544 to switch the forwarding destination of requests, waits for the active Web application to finish processing, and finally gives an instruction to undeploy the active Web application.

The processing status management unit 606 of the request switch 544 may send the “processing completed” status after a given period of time (e.g., a few seconds) elapses after a time at which an instruction to switch from the active Web application to the standby Web application is issued. In this case, the active Web application can be stopped forcibly when it takes very long for the active Web application to finish processing, and a switch from the active Web application to the standby Web application is carried out without fail. A failure due to resource leak is thus prevented.

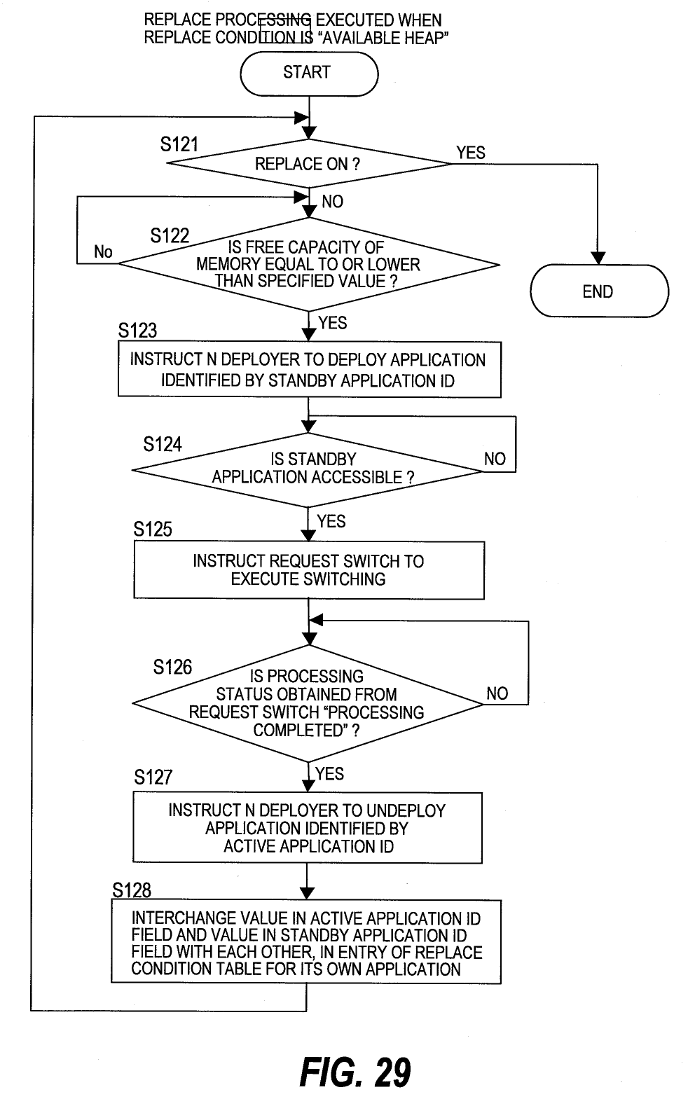

FIG. 29 is a flow chart showing an example of processing that is executed by the replace management unit 5435 of the replace manager 543 when the replace condition 5432 is “available heap”. This processing is similar to the one in FIG. 28 in that it is invoked for each application context 5431 in the replace condition table 5430.

In Step S121, the replace management unit 5435 checks whether or not the replacing is to be carried out, executes steps that follows Step S121 if the replacing is to be carried out and, if not, ends the processing as in FIG. 28.

In Step S122, the replace management unit 5435 checks the size of the available heap and waits until the available heap becomes smaller in size than a value set in the replace condition table 5430. When the size of the available heap reaches the set value or smaller, the replace management unit 5435 proceeds to Step S123. Steps S123 to S128 are the same as their corresponding steps shown in FIG. 28.

Through the above processing, each time the available heap becomes a given size or smaller, the replace management unit 5435 makes sure that the standby Web application is deployed, then instructs the request switch 544 to switch the forwarding destination of requests, waits for the active Web application to finish processing, and finally gives an instruction to undeploy the active Web application.

In this embodiment, as has been described, one active Web application (App1.ear) and at least one standby Web application (App2.ear) are created from the original (App.ear) of one Web application 55, as well as the request switch 544 (App.war) for forwarding requests from Web servers and clients to the active Web application or the standby Web application, and a replace condition for replacing the active Web application with the standby Web application is set in the replace manager 543 in advance.

The replace manager 543 monitors the replace condition 5432 set in the replace condition table 5430 for each Web application 55 and, when the replace condition 5432 is met, has the N deployer 545 deploy the standby Web application first and then instructs the request switch 544 to execute the switching. The request switch 544 switch the forwarding destination of requests sent by the Web servers 4 from the active Web application to the standby Web application. The replace manager 543 makes sure that the former active Web application has finished processing all requests, and then undeploys the former active Web application to free up a memory space that has been used by the former active Web application.

Thus freeing only a memory space for the Web application, where resource leak is likely to occur more than any other software tier components (OS, JVM, and application server which run the Web application 55), makes it possible to prevent a failure, while the OS, JVM, and application server left in the memory and the cache minimize lowering of the cache hit rate and accordingly minimize performance degradation.

Furthermore, the Web servers 4 can receive results of requests without delay and immediately forward the results to the client because it is not until the standby Web application is deployed that the request switch 544 is put into operation to forward requests to the standby Web application instead of the active Web application. This way, switching of Web applications as a preventive measure against resource leak can be carried out smoothly, without suspending reception of requests like in prior art.

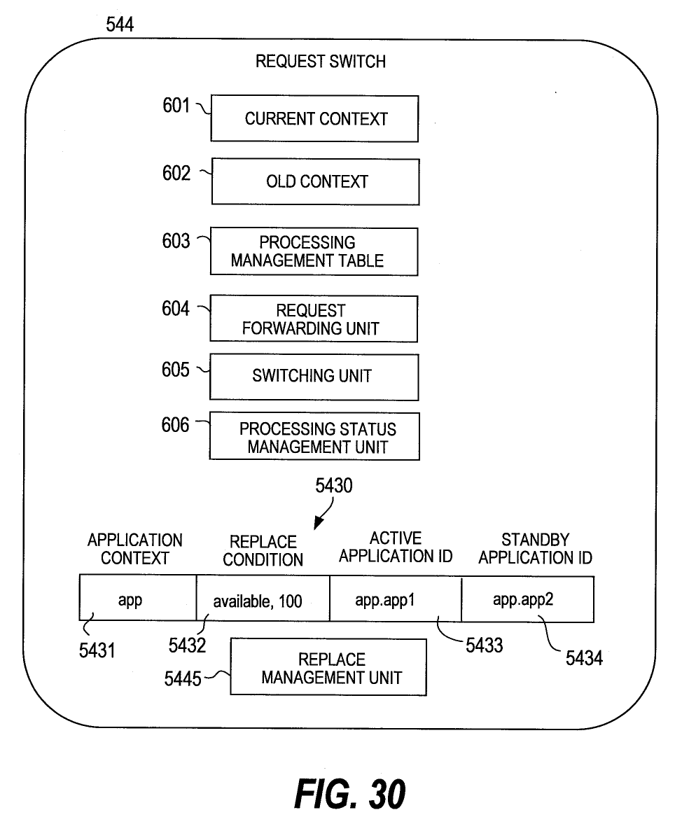

The request switch 544 and the replace manager 543, which, in the first embodiment, are different modules, may be integrated into one module as shown in FIG. 30. The replace condition table 5430 in this case is used to manage only one Web application 55, namely, its own application, and the same effects as those listed above are obtained.

### Second Embodiment

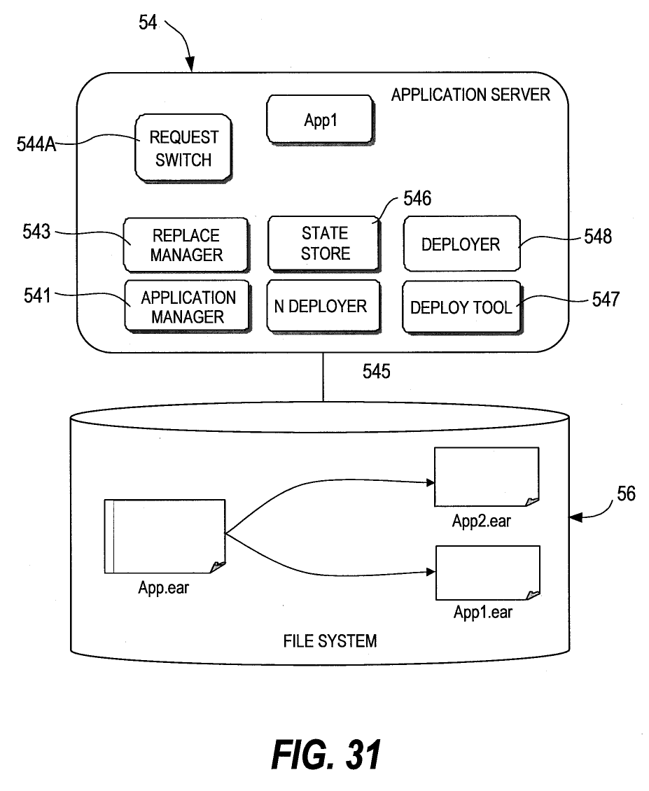

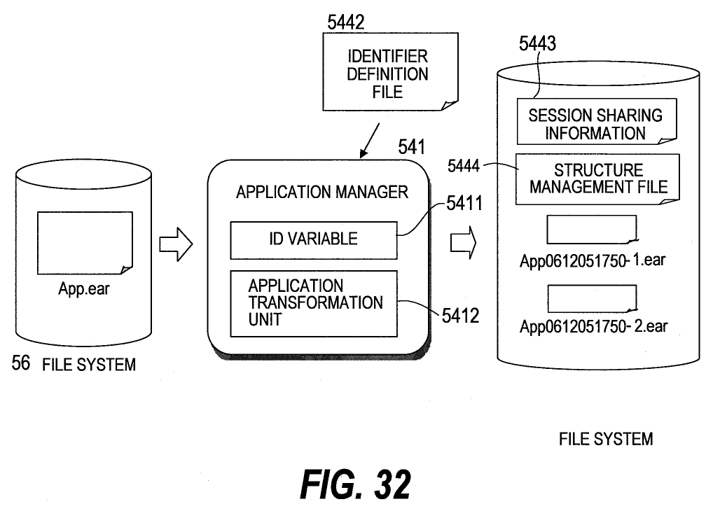

FIGS. 31 and 32 show a second embodiment in which the request switch 544 is incorporated in the application server 54 whereas the request switch 544 in the first embodiment is constituted of a file “App-rs.war”. The rest of the second embodiment is the same as the first embodiment.

The application manager 541 shown in FIG. 31 creates the active Web application App1.ear and the standby Web application App2.ear in the file system 56 of the memory (or of the storage system) from the application App.ear, which is the original of the Web application 55 for providing a service.

A request switch 544A is a module set in advance in the application server 54, and is set so that requests from the Web servers 4 are forwarded selectively to the active Web application App 1.ear and standby Web application App2.ear created by the application manager 541. The request switch 544A has the same functions as the request switch 544 does in the first embodiment.

FIG. 32 is a diagram showing how the application manager 541 creates the active Web application App1 and the standby Web application App2. As in FIG. 11 described in the first embodiment, the application manager 541 obtains the value of the ID variable and the identifier definition file 5442 from the specified Web application 55, “App.ear”, to create the context names of the active Web application App1 and the standby Web application App2. The application manager 541 in the second embodiment creates the active Web application and the standby Web application, but not the request switch.

The difference from the first embodiment is that the N deployer 545 does not deploy the request switch 544A, which is incorporated in the application server 54. The rest of the second embodiment is the same as the first embodiment.

The request switch 544A switches the forwarding destination of requests sent by the Web servers 4 from the active Web application to the standby Web application the same way the request switch 544 does in the first embodiment. The second embodiment thus provides the same effects that are obtained in the first embodiment.

### Third Embodiment

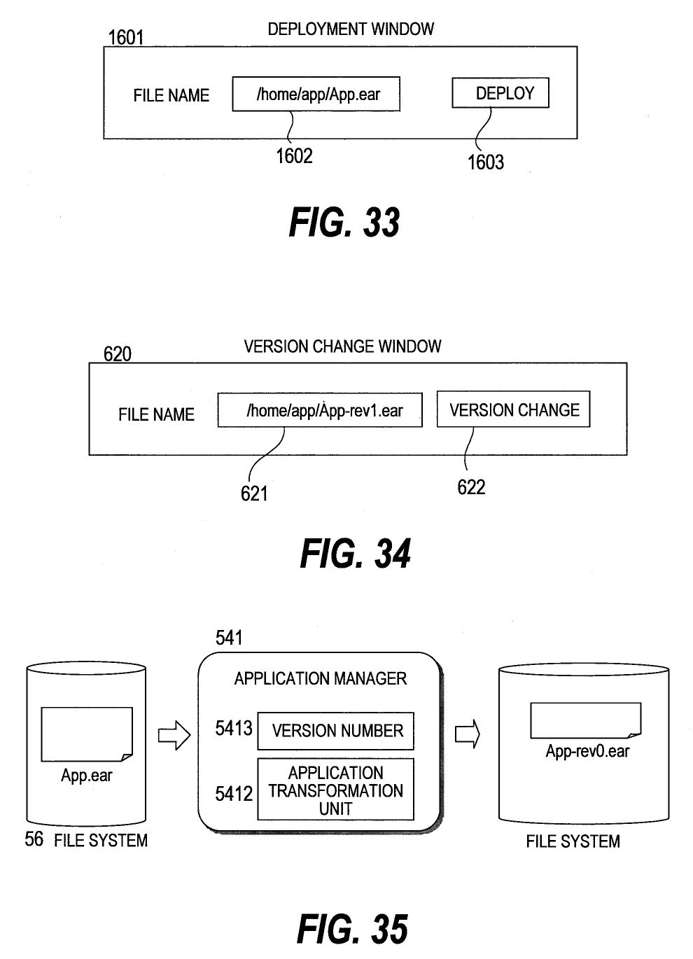

FIGS. 33 to 38 show a third embodiment obtained by adding to the second embodiment an online version change function, which is used to change the version of the Web application 55 (App.ear) on line. The rest of the third embodiment is the same as the first embodiment or the second embodiment.

It is a common practice to change the versions (or revisions) of Web applications, such as the Web application 55, and other similar programs (to a newer version or back to an older version) as the developer of the program performs bug fix or adds a new function. This embodiment shows an example of changing, on line, the version of the Web application 55 that is in operation.

FIG. 33 shows a modified design of the deployment operation window 1601 described in the first embodiment with reference to FIG. 5. The deployment operation window 1601 of FIG. 33 does not have any of the fields for entering information about the replacing that are shown in FIG. 5. The rest of the deployment operation window 1601 in the third embodiment is the same as in the first embodiment.

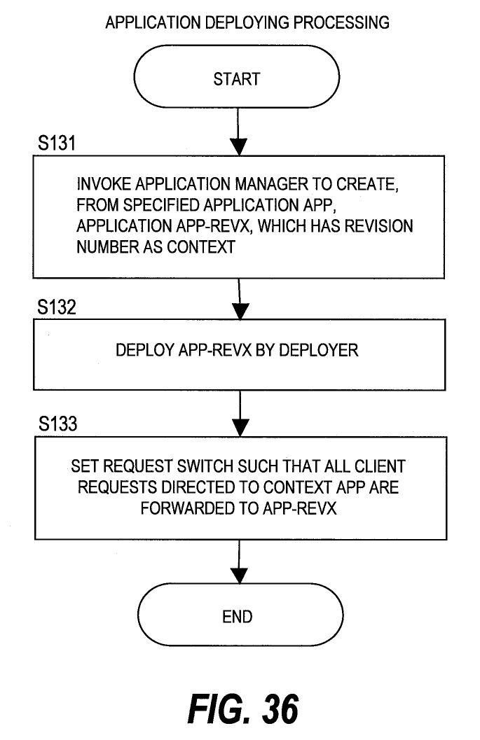

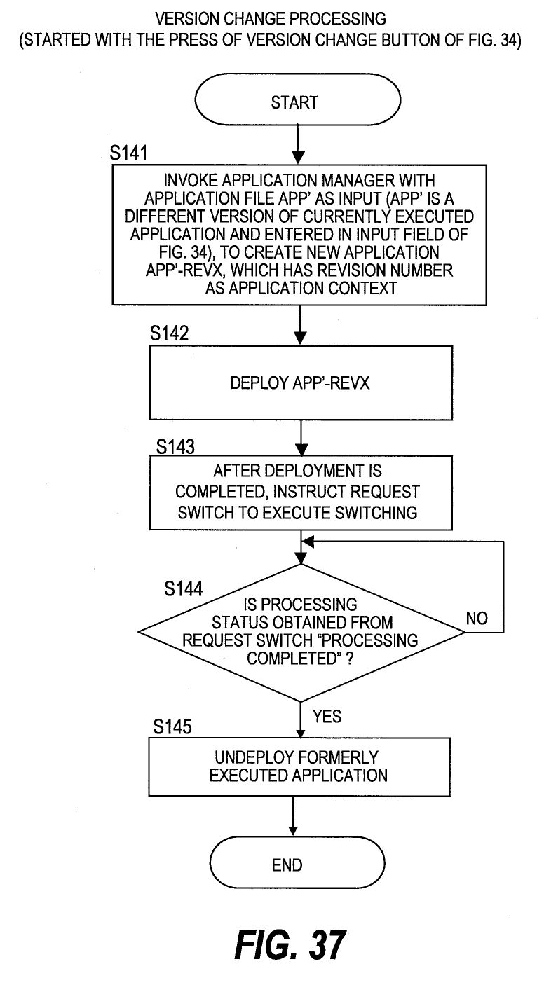

FIG. 34 shows a version change window 620, which is provided to the administration console 7 by the application server 54 to change the version of the Web application 55. The version change window 620 has a field for a file name 621 in which the file name of a Web application to be executed in place of a Web application that is currently run and a version change button 622 with which an instruction to carry out a version change is given.

An administrator or the like operating the administration console 7 specifies the file name 621 and clicks on the version change button 622, thereby sending a version change instruction to the application manager 541 of the application server 54.

FIG. 35 is a block diagram showing the behavior of the application manager 541. The application manager 541 has, in addition to the application transformation unit 5412 and the ID variable obtaining unit 5411, which are described in the first embodiment with reference to FIG. 11, a version number management unit 5413 which manages the version number of the Web application 55.

The version number management unit 5413 manages a version number for each Web application 55 (App.ear). When the application manager 541 creates an application, the version number management unit 5413 adds a version (or revision) number to a context name to create an identifier for the created Web application 55. For instance, when the version number of the application App.ear in FIG. 35 is 0, an application created from the application App.ear is “App-rev0.ear”. It should be noted that, although the ID variable is omitted in FIG. 35, the ID variable is attached to the context name of the application as described in the first embodiment with reference to FIG. 11.

FIG. 36 is a flow chart showing an example of processing that is executed when the application server 54 receives a version change instruction.

In Step S131, the application manager 541 is invoked and creates an application to be executed, “App-revX.ear”, which is obtained by attaching a version number (revX) to the context name of a specified application as described above with reference to FIG. 35.

In Step S132, the application server 54 invokes the N deployer 545 to deploy in the memory the application App-revX.ear created by the application manager 541. In Step S133, the application server 54 sets the request switch 544A so that requests sent by the Web servers 4 are forwarded to the application app-revX.ear, and then ends the processing.

To apply this example to the first embodiment, the Web servers 4 instead of the application server 54 set the application App-revX.ear in the request switch App.war as the forwarding destination of the requests.

FIG. 37 is a flow chart showing an example of processing that is executed by the application server 54 when a version change instruction is given in the version change window 620 of FIG. 34.

In Step S141, the application server 54 invokes the application manager 541 in response to a version change instruction received from the version change window 620, and creates an application whose application context has a new version number in the manner described with reference to FIG. 36.

In Step S142, the N deployer 545 is invoked to deploy in the memory the application App-revX.ear created by the application manager 541 and having the new version number.

In Step S143, the application server 54 instructs the request switch 544A to replace the application App.ear serving as the active Web application with the application App-revX.ear serving as the standby Web application. The request switch 544A executes the processing described in the first embodiment with reference to FIG. 25. Specifically, the request switch 544A copies the application App.ear which has been stored as the current context 601 to the old context 602, stores the application App-revX.ear as the current context 601, and updates the processing management table 603. In Step S144, the application server 54 waits for the application that is now registered as the old context 602 to finish processing as in Step S126 of FIG. 29 which is described in the first embodiment.

In Step S145, after the application App.ear registered as the old context 602 finishes processing all requests, the application server 54 instructs the N deployer 545 to undeploy the application App.ear registered as the old context 602.

Through the above processing, the Web application 55 that is being executed is replaced with a different version of the application. The third embodiment thus accomplishes version change that does not involve interruption of the current Web application 55 nor suspension of reception of requests from the Web servers 4.

The third embodiment is an example of applying the online version change function to the second embodiment, but the same effects can be obtained also when the online version change function is applied to the first embodiment where the request switch 544 is created from App.ear which is the Web application 55.

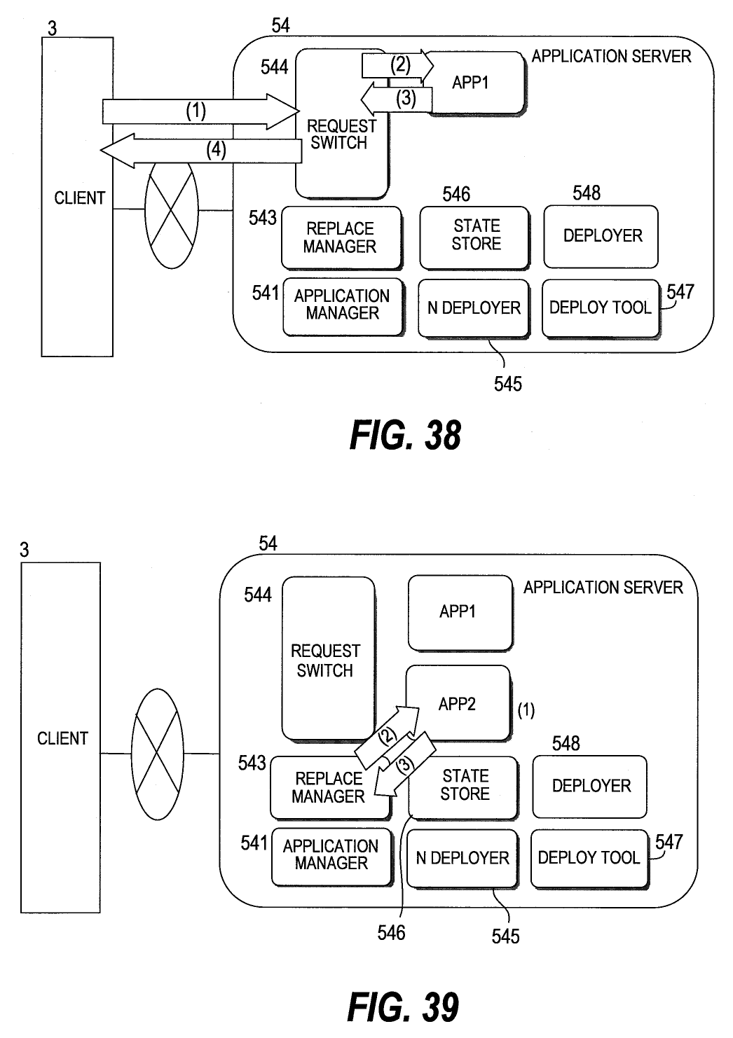

The first to third embodiments are summed up as shown in FIGS. 38 to 41. First, the application manager 541 creates a first Web application and a second Web application. Next, as shown in FIG. 38, the application server 54 executes the first Web application (App1), the request switch 544 (or 544A) receives a processing request from one of the clients 3 through one of the Web servers 4 and increments the value of the counter (“value” in the processing management table 603) before forwarding the processing request to the first Web application ((1), (2)), and the first Web application executes the processing request. The first Web application sends a result of executing the processing request to the request switch 544 ((3)), and the request switch 544 decrements the value of the counter (“value”) before sending the result to the client 3 through the Web server 4.

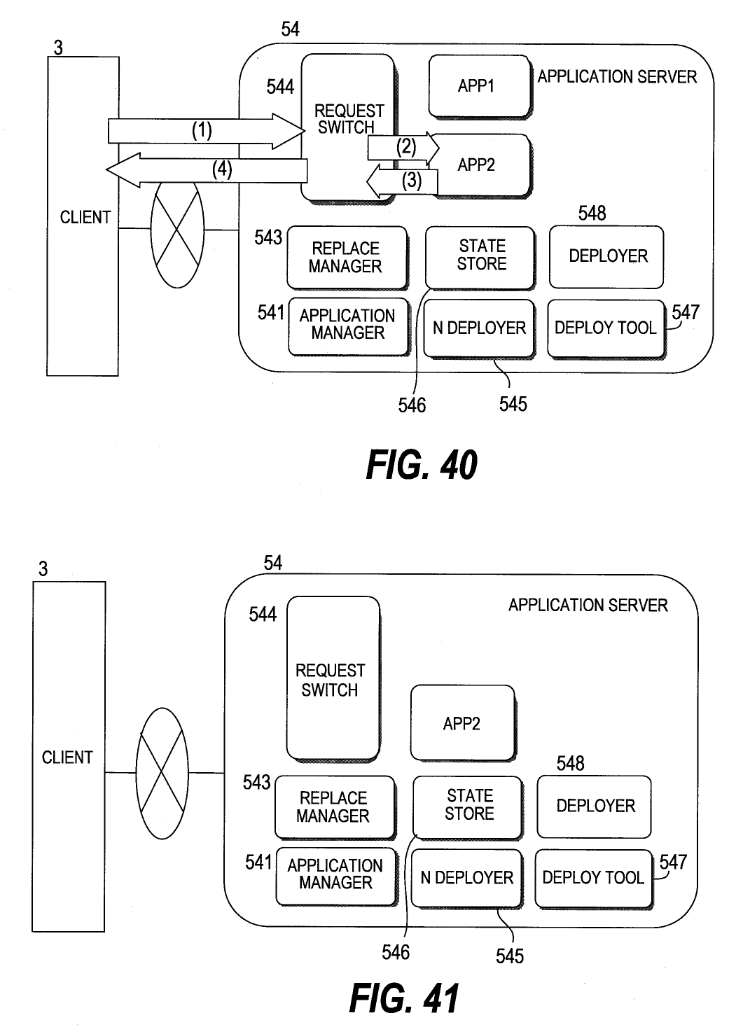

Next, as shown in FIG. 39, the replace manager 543 instructs the N deployer 545 to deploy the second Web application in the memory, and waits until a service of the second Web application becomes available. After the deployment of the second Web application is completed, as shown in FIG. 40, the replace manager 543 instructs the request switch 544 to switch the forwarding destination of requests from the first Web application to the second Web application, and waits for the first Web application to finish processing all requests.

After the first Web application finishes processing the requests, as shown in FIG. 41, the replace manager 543 instructs the N deployer 545 to undeploy the first Web application. This frees a leaked unnecessary memory and prevents a failure. This also leaves most of the execution environment of the Web application 55, including the OS, the JVM, the application server, the request switch 544, and the replace manager 543, thereby preventing performance degradation due to lowering of CPU cache hit rate which occurs in prior art immediately after the first Web application is replaced by the second Web application. Furthermore, the request switch 544 makes a seamless switch from the first Web application to the second Web application possible without suspending reception of requests.

### Fourth Embodiment

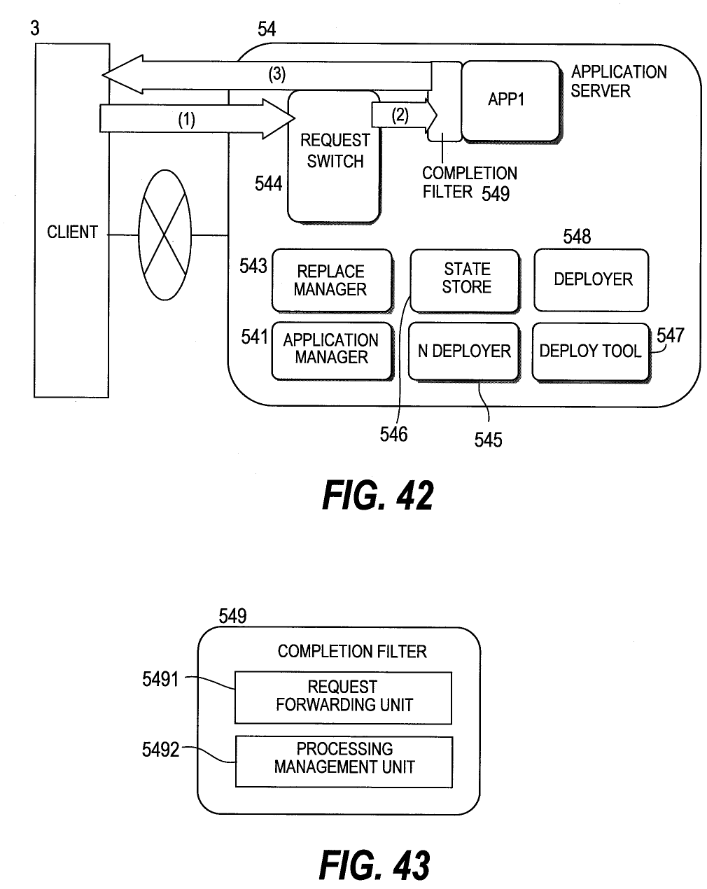

FIGS. 42 and 43 show a fourth embodiment in which the Web application 55 (App1 shown in FIG. 42) itself, instead of the request switch 544 in the first to the third embodiments, sends a processing result to the client 3 through the Web server 4. The rest of the configuration of the fourth embodiment is the same as those of the first to third embodiments.

In FIG. 42, the Web application App1 receives a processing request sent by the Web server 4 through the request switch 544 ((1), (2)). The Web application App1 sends a result of executing the processing request to the client 3 through the Web server 4. Because the Web application App1 sends the processing result directly to the Web server 4, the request switch 544 has no way of detecting that the Web application App1 has finished processing.

To prevent this problem, the Web application App1 is equipped with a completion filter 549, which counts how many requests are currently being executed and notifies the request switch 544 when all the requests finish being processed. The completion filter 549 has, as shown in FIG. 43, a request forwarding unit 5491, which forwards requests received from the request switch 544 to the Web application App1, and a processing management unit 5492, which counts how many requests are input to the Web application App1 and how many processing results are output from the Web application App1 to judge whether the Web application App1 has finished processing. The processing management unit 5492 has a configuration similar to that of the processing status management unit 606 in the first embodiment, and is capable of notifying the request switch 544 and the replace manager 543 of the completion of processing of a processing request input to the Web application App1 (status).

Thus, attaching the completion filter 549 to the Web application 55 that sends a processing result directly to the Web server 4 makes it possible to ensure that the first application finishes processing all requests before being undeployed as in the first to third embodiments.

The filter attached to the Web application 55 may be, for example, a Servlet Filter.

A Servlet Filter is a mechanism for adding processing at the entrance and exit of an application without changing its application code, and this function is utilized to detect the completion of processing of a request. The completion filter 549 is not dependent on any specific application, and the application manager 541, in creating two applications, the active (App1.ear) and the standby (App2.ear), from a designated Web application, inserts the completion filter 549 to both the active Web application App1.ear and the standby Web application App2.ear.

The request switch 544 shown in FIG. 42 does not execute the processing status management unit 606 unlike the request switch 544 of the first embodiment shown in FIG. 22. Instead, the request switch 544 shown in FIG. 42 cooperates with the completion filter 549 of each Web application to manage how many requests are being processed.

The above embodiments show examples in which the application manager 541 creates from the original Web application 55 a first application (the active Web application) and a second application (the standby Web application or a different version of the active Web application), and the request switch App.war. Alternatively, the first and second applications and the request switch 544 may be created in the file system 56 in advance. An effect obtained by employing this mode, in addition to the effects of the first to third embodiments, is improved response performance because a processing result reaches the client skipping the request switch.

As has been described, this invention is applicable to a computer system that provides a service through a Web application and a program that controls a Web application.

While the present invention has been described in detail and pictorially in the accompanying drawings, the present invention is not limited to such detail but covers various obvious modifications and equivalent arrangements, which fall within the purview of the appended claims.

What is claimed is:

1. A highly available application operation method for replacing a first application which processes requests from clients with a second application which processes requests from clients, comprising the steps of:
forwarding requests to the first application;
when a given condition is met, invoking the second application and forwarding a new requests to the second application; and
when the first application completes the processing of all requests after the completion of second application invocation, stopping the first application.

2. The highly available application operation method according to claim 1, further comprising the step of creating, from a preselected application, the first application and the second application which have different identifiers.

3. The highly available application operation method according to claim 2,
wherein the step of creating the first application and the second application which have different identifiers comprises the step of creating a request transfer unit, which switches a forwarding destination of the received requests from the first application to the second application; and
wherein the request transfer unit executes the step of forwarding received requests to the second application.

4. The highly available application operation method according to claim 2, wherein the step of creating the first application and the second application which have different identifiers comprises the steps of:
extracting, from the preselected application, a first portion containing an identifier and a second portion containing a program that describes given processing;
attaching a new identifier that indicates the first application to the identifier in the first portion, and then joining this first portion and the second portion to create the first application; and
attaching a new identifier that indicates the second application to the identifier in the first portion, and then joining this first portion and the second portion to create the second application.

5. The highly available application operation method according to claim 2, further comprising the step of receiving requests and forwarding the requests to the preselected application,
wherein the step of forwarding the requests to the preselected application includes the steps of monitoring for completion of processing of the forwarded requests and, when processing of every request that has been forwarded before a preset point in time is completed, notifying the completion.

6. The highly available application operation method according to claim 2, further comprising the step of receiving requests and forwarding the requests to the preselected application,
wherein the step of forwarding the requests to the preselected application includes the steps of:
monitoring for completion of processing of the forwarded requests, and recording requests that are forwarded before a preset point in time;
deleting the recorded requests after a given period of time elapses because the preset point in time; and
notifying completion after the recorded requests are deleted.

7. The highly available application operation method according to claim 1, further comprising the steps of:
processing, by the first application, the received request and relaying a result of this processing from the first application; and
returning the relayed processing result to a sender of the request.

8. The highly available application operation method according to claim 1, further comprising the steps of:
processing, by the first application, the received request and returning a result of this processing to a sender of the request from the first application; and
judging that the request has been completed upon returning of the processing result.

9. The highly available application operation method according to claim 1, wherein the step of invoking the second application and forwarding received new requests to the second application includes the steps of:
waiting for the second application to be ready to process requests; and
forwarding the received new requests to the second application after the second application becomes executable.

10. The highly available application operation method according to claim 1, wherein the step of stopping the first application when the first application completes the requests processing includes the steps of:
waiting until every request forwarded to the first application finishes being processed; and
discarding the first application after the first application finishes processing all the requests.

11. The highly available application operation method according to claim 1, wherein the step of forwarding the requests to the first application includes the steps of:
deploying the first application in a memory of a computer; and
deploying, in the memory, a request transfer unit which forwards received requests to the first application.

12. The highly available application operation method according to claim 1, wherein the first application and the second application have the same function, and a version of the second application differs from a version of the first application.

13. A method of changing application version on line to replace from a current application to a new application to change version of the application which receives requests, comprising the steps of:
invoking the current application and forwarding the received requests to the current application;
when a given condition is met, invoking the specified different version of application to send received new requests to the different version of application; and
when the current application completes the requests after the different version of application is invoked, stopping the current application.

14. A computer system, comprising:
a deploying unit which deploys a first application and a second application in a memory; and
a request transfer unit which forwards received requests to one of the first application and the second application,
wherein the computer system further comprises a replace manager which switches the first application to the second application,
wherein the replace manager is comprised to:
send an instruction to the request transfer unit to switch a forwarding destination of requests from the first application to the second application after the deploying unit invokes the second application; and
instruct the deploying unit to discard the first application after the first application finishes processing.

15. The computer system according to claim 14, further comprising a session storing unit which holds session information used by the first application,
wherein the second application reads the session information to obtain the session information that is written by the first application and is held in the session storing unit.
